(19) United States
(12) Patent Application Publication
(10) Pub. No.: US 2005/0193222 A1
(43) Pub. Date: Sep. 1, 2005

(54) Providing secure data and policy exchange between domains in a multi-domain grid by use of a service ecosystem facilitating uses such as supply-chain integration with RIFD tagged items and barcodes

(76) Inventor: William Sprott Greene, Fairview, TX (US)

Correspondence Address: William Sprott Greene, 1461 Meandro Ria, Fairview, TX, 75069, US

(21) Appl. No.: 11/069,479

(22) Filed: Mar. 1, 2005

Related U.S. Application Data
(60) Provisional application No. 60/548,920, filed on Mar. 1, 2004.

(51) Int. Cl. H04L 9/00

(52) U.S. Cl. 713/201

(57) ABSTRACT

A system, method, and software implemented system of services provides enhanced security and management to multiple domain grids and allows intercommunications between the different grid domains providing for secure data exchange, policy exchange, and agent exchange between grids or grid domains. Via the exemplary example, utilizing the unique characteristics of the Service Grid and mobile agents, this is extended to provide enhanced security and management to supply chains: providing data exchange, policy exchange, and agent exchange between supply chain nodes and supply chain partners—facilitating enhanced methods of supply chain automation when using barcodes and Radio Frequency Identity (RFID) tags to identify and track goods through supply chains and consumer uses. Agents transport data and policy between supply-chain partners over an extranet, migrating across corporate boundaries and security domains, locating near where items are identified to provide local control, environmentally responsive policy, and ongoing permanent data capture & history.

### CROSS-REFERENCE TO RELATED APPLICATIONS

The present application is related to and claims priority from co-pending U.S. Provisional Application 60/548,920 filled on Mar. 1, 2004, and entitled “Use of an Assurance Ecosystem to Provide Secure Supply-Chain Integration with RIFD tagged items and Barcodes”. The above-identified application is incorporated in its entirety herein by reference.

The present application is related to and claims extensions to co-pending U.S. patent application “Ser. No. 10/913,887—System and Method for Use of Mobile Policy Agents and Local Services, Within a Geographically Distributed Service Grid, To Provide Greater Security via Local Intelligence and Life-Cycle Management for RFID Tagged Items”.

### STATEMENT REGARDING FEDERALLY SPONSORED RESEARCH OR DEVELOPMENT

N/A. No federal funding.

### REFERENCE TO SEQUENCE LISTING, A TABLE, OR A COMPUTER PROGRAM LISTING COMPACT DISK APPENDIX

N/A. None provided.

### BACKGROUND OF THE INVENTION

1. Field of the Invention

The present invention relates to network and information technology. Still further, the invention relates to providing service grid IT infrastructure for business services and automation.

More particularly, the present invention relates to providing enhanced security and management to multiple domain grids and allowing intercommunications between the different grid domains. Still further the present invention relates to providing data exchange, policy exchange, and agent exchange between grids or grid domains.

More particularly, via the exemplary example of the above, the present invention relates to providing enhanced security and management to supply chains. Still further the present invention relates to providing data exchange, policy exchange, and agent exchange between supply chain nodes and supply chain partners.

2. Reference Terminology to the Invention

As shorthand, the ecosystem of this invention is referenced by the simplified name Service Grid instead of the entirety of the extended description. In explaining the exemplary example, the use of mobile policy agents and security gateways in supply chain information transmission and integrations, reference is made to specific service names. These are described in patent application: “Ser. No. 10/913,887—System and Method for Use of Mobile Policy Agents and Local Services Within a Geographically Distributed Service Grid, To Provide Greater Security via Local Intelligence and Life-Cycle Management for RFID Tagged Items” and in related art.

3. Description Of Related Art

4. Service Grid Invention Background

The Service Grid described herein is an advancement on several prior versions of service grids, service ecosystems, and semantic grids.

This specific invention enhances on standard service grids. Current art has these as static deployments of web-services on application servers. These heritage business grid deployments, the Globus grid standards, the Global Grid Forum OSGA architectures, and the Globus Business Service Grid designs, and the prior service grid inventions of the author can be implemented as functional subsets of this newly described Service Grid.

This significantly enhanced Service Grid architecture combines aspects of several longstanding fields of research in computer science. Briefly, these include:
Grid Computing
Component Framework Architectures
Service Oriented Architectures (SOA) a Space-Based Computing (Jini & JavaSpaces)
Semantic web services
Mobile Agent Technology
Peer-to-Peer (P2P)/Groupware
Distributed databases
Policy, Rules & Process Management
Secure VPNs & Policy-based Networking

Some of these foundation technologies are often implemented in standards, intellectual property, products and patents granted and now owned by:
MCI's Global Ecosystem (pending patents by self-same Inventor)
IBM's Aglets
Sun Microsystems's Jini & Javaspace
Sun Microsystems's Rio
Cisco SI
Grid computer companies
EPCglobal standards
TeleManagement Forum NGOSS standards work
Globus Alliance & Global Grid Forum
Semantic Web and Semantic Grid designs

### Best Current Practice in Component Architecture

The Service Grids^{SM} builds upon and extends past work in component framework architectures (CFA). This prior work includes:
OMG Component Architectures: OMG component architectures are standardized by the Object Management Group and resulted in the CORBA II specification. CORBA provides a tight, compile time model of service binding which experience shows results in application rigidity and development delays. The specific CORBA II technology is decreasing in market acceptance as newer systems occur. However, OMG is taking on new roles in technology neutral specification of inter-operative component systems.
EJB Architectures: By far the most dominate expression of a CFA in today's market. EJB provides for a an application server (instead of a container) which coordinates interaction of services. There are utility framework services provided through standardized interfaces. It uses a tight design model of service binding, but a runtime binding of the utilities. Rigid interface design means new framework services are developed though a complex and time consuming standardization process.
Microsoft COM+, DCOM & NET: The newest entrant into CFA, Microsoft provides a loosely organized set of utility services which enable remote communication between services. These facilities, coupled with characteristics of the C# language, can be used to develop an ecosystem just as Java language does.
NGOSS Component Architecture: Widely recognized as the strongest integration of Business Process Modeling and Component Framework Architecture. New Generations Operating Systems Software (NGOSS) provides a strong documentation of binding definitions via a Contract artifact. NGOSS provides an emphasis on delivery of business logic as Process and Policy as segmented from Framework Utility services. It also advocates utilization of a common information model as an aid to integration of components built and delivered by different suppliers. Both technology neutral requirements and specifications and technology specific working examples are provided in the standardization processes.
Distributed Object Systems: Distributed Object Systems: Several historical systems have provided systems where objects discover each other and exchange information. These rely on inheritance to provide common interfaces among the objects that then use generally rigid framework services to coordinate communication. It is possible to extend these systems via service grids.

While this patent derives from a broad base of prior art, yet it provides for a novel integration and adaptation of many ideas in unique ways such that the result enhances use and expands applicability of these foundation technologies.

This invention is not derived from nor dependent on client server object technology, database-centric information systems, and shared-memory object caching systems. Specifically, the computing practices described herein depart significantly for this prior art and exist to correct issues in these prior approaches. Few prior schools of programming techniques, other than those described in related SOAs, grids, and components architecture technology apply (*there are no records here). These systems are all near-real-time.

### Best Current Practice in Service Grid Architecture

Grid service architectures are the future of computing. These systems call for a physically distributed group of computers interconnected by a network. Services run in these computers and use the network to communicate with services on other computers. It is basic in a service grid that services are not autonomous—either by design or deployment; services rely on interacting with other services to get the jobs done.

Service Grid Retrospective:

Grids came into existence soon after computers began to be networked. In the 1970s they were used to build complex graphics. 1980's they were doing tasks like compiling IBM's OS2 operating system, overnight during OS2 development, a task that took 60 some PS2 microcomputers each being passed a small part of the compilation and linking task. Job control in these early systems tended to be hierarchical. But these were specialized, one-off uses, painstakingly designed to solve unique problems of the time. And they had yet to be called grids. Modern grids arose in the mid 1990's and are rapidly evolving. Generally the practitioners in the field classify grids into 3 generations, but all three generations are in simultaneous use and undergoing market driven enhancements.

Generation one grids were applied to massively parallel problems, providing efficiency in solving application problems which required enormous quantity of computing cycles and resources. Examples include computing aerodynamic efficiency and developing new drugs. Most grid deployments today address this issue and are characterized by special purpose grids that are not shared in use, existing for one department and one problem class. Mostly the computers are linked in high-speed local area networks; or are supercomputers linked via high-speed, specialized internets. Problems are broken into many parallel processing strands controlled by a work manager. This is “moving the problem to the compute resources.”

Generation two grids link data repositories and share data. As data repositories outgrew efficient size for databases, multiple databases were needed and these needed to be coordinated. Oracle 10 g is a successful market technology for coordinating many databases and database access over many servers and databases [utilizing XA data transaction standards]. This is “moving the problem to the data repository” or just possibly, “moving the data storage close to the problem.” Very large data scale is the predominate market characteristic. The scope of usefulness is larger with concurrent market expansion, but still limited to very large, high transaction traditional applications.

Generation three grids expand the scope of grid use to nearly any general business problem. Computers in the third generation grid are physically distributed and connected by Virtual Private Networks (VPNs) and wide area networks (WANs). In one sense, generation three grids are a natural outgrowth of pervasive networking of computers, but actually they reverse the dominate trend in networking computers that organizes server computing in a central location with peripheral computers collecting data and providing user/client interfaces. Instead, computing occurs in servers close to the business process owner or business domain which then communicates with servers close to other business domains. This is “moving the computing to the problem.”

Business Service Grids are the 3rd generation of software grids. Business Service Grids link computers at dispersed business locations to provide coordinated business activities. Service Grids are also about the software which allows the applications to be dispersed along with the servers. The technology is just now emerging, has not reached any technical consensus and certainly is not matured. No existing market exists, except for specific very tough problems attacked on a one-off basis by powerhouse service companies like IBM, and then only when their traditional technology cannot be applied. Nevertheless, IBM has recognized Service Grids are the future of computing and has embarked on a large advertising campaign in this area. HP has also begun exploring this realm with what they call “autonomic computing.” Some early standardization is occurring in Globus under the name “Business Service Grids” but these standards are closely linked with web service technology.

For a comparative representation of current grids vs service grids see “FIG. 1: Contrasting Service Grids to other Grids” and the accompanying figure description.

The Service Grid used as an exemplary example in this applications builds upon and extends past and present work in service grid architectures (CFA). This prior work includes:

MCI Worldcom's NewWave: The original application ecosystem, NewWave was developed at MCI Worldcom during 1998-2001. This inventor is one of the existing patent submitters on NewWave technology which to date includes 13 patent applications several at USTPO “Approved” status. The base patent id, of this group, is: “09/863,456—METHOD AND SYSTEM FOR MANAGING PARTITIONED DATA RESOURCES”; however, the logical foundation patent is referenced in the claims within: Ser. No. “10/112,373—METHOD AND SYSTEM FOR IMPLEMENTING A GLOBAL ECOSYSTEM OF INTERRELATED SERVICES”. This Service Grid depart significantly from that the prior art.

Global Grid Forum (GGF) Grid Services: Originator of the Service Grid term for this type of distributed computing the GGF brought together server academic groups and business industry leaders to define a common standard. This architecture is not technology neutral. Basic architecture calls for Application Servers fixed to a Computing Grid to discover each other and invoke distance services via web service exchanges. It also provides for Job scheduling and distribution of tasks on the Application Server Grid. The standardization of framework services and communications interfaces is significant. A Service Grid would likely implement many of these facilities to facilitate interoperability with this family of business service grids. However, the specific improvements embodied in this invention greatly improve upon the remote web service message exchange used in these standards.

### Improvements to Prior IT Technology

Each of these fields has proceeded on its own for years with varying degrees of success. Grid Computing, for example, is a viable and cost-effective method for handling large computational tasks. Jini's technical advantages have been overshadowed by the fact that mobile devices have failed to progress rapidly enough, and mobile agents do not work collaboratively and therefore have limited utility. The Service Grid was influenced by each of these computing technologies; relevant principles were used when they supported the goals of delivering mission critical communications in a global system.

Most grids in service today can only be used for a narrow rage of problems dealing with compute intensive tasks, limiting their marketability. Most business problems do not fit this category. Architecturally, current grid product offerings are designed to connect servers and distribute parallel bits of work; these tend to only run over high speed local area networks (LANs) substituting cheaper servers for supercomputers. Technically, these products modify the operating systems of servers to make multiple servers more like parallel processing systems and then add work distributors and job control applications. The most advanced provide extensions of EJB so the system looks like one enterprise application server. These solutions tend to only allow one problem or application to use the grid at any time; significantly reducing business applicability and customer value.

The Service Grid works at the application layer. No modifications to existing operating systems are needed (except that fully secure operations require certified secure OS); nor is support limited to one vendors OS. The service grid distributes applications by providing architecture that leverages distributed computing and understands and utilizes network characteristics; packaging and building in this understanding so the customer is sheltered from these complex concerns. Service grid applications are designed as sharable sub-parts (services) that run in different servers and intercommunicate over the grid. Virtually any business application can be re-engineered to run over the service grid. Further, any and all applications can share the grid at the same time.

The service grid allows computers to participate in the grid no mater where they are located. Physically, the service grid works over both LANs and Wide Area Networks (WANs). The service grid can co-exist and ride over OS based grids extending their applicability to many simultaneous shared tasks. The service grid is suited to coordinate business process over global reaches. A unique approach, described in this application, to federating domains of activity allows the service grid services to interact efficiently in LANs while utilizing information and providing services wherever the WAN reaches. Lastly, the service grid has information about network architectures so it can efficiently distribute work everywhere compute resources are joined to the grid.

By applying deconstruction and dispersion, traditional applications can be disassembled and scattered over a grid. (See “FIG. 19: Deconstruction is used to design reusable services for the Service Grid”.) In deconstruction, large monolithic application systems are broken down into many, smaller services. Each of these services controls one small part of the overall application functionality, perhaps a single business process, or the responsibility for one type of data. Dispersion is scattering small servers across the network. It allows business processes programs to run close to where the business activity they support actually occurs. Mobile agent technology is used to place automated policy and process control in the servers near where business takes place.

The service grid is a further step in this evolutionary chain that fuses Business Service Grids and Data Grids by incorporating mobile agent technology and policy control.

In order to clearly explain and contextualize this technological innovation, it is necessary to define some basic terms. Service Grid is a Service Oriented Architecture (SOA) for component applications. Services are programs with a dedicated function that have a simple and standard way of communicating with other services. Component applications are applications built from elemental pieces (components) that work in concert to perform more complex tasks. ‘Microservice’ is the new term invented in prior referenced specifications and applied to components in its architecture. At a high level, our Service Grid is designed to handle the following problems that arise when deploying a large number of Microservices in a geographically diverse environment of multiple companies and security domains:
How will Microservices from different domains recognize and find each other?
How will separate grids and companies communicate in an effective and scalable manner?
How will Microservices securely transition grid domains?
How will companies negotiate and control these transfers?

This invention uses a distributed component software framework, like EJB or COM+, which defines how Microservices should be built and how they will interact. The Service Grid provides:
A middleware platform for communication and coordination between Microservices
A management platform for self-regulation and a single point of global control over deployment, performance, and security
Specialized JVM (Java Virtual Machine) or NET remoting containers for running the Microservices dynamically
A library of pre-built Microservices to speed application development

Java developers writing applications for Service Grid use the same development methods and tools they have always used. The difference is that instead of writing their Java applications as EJB components to run inside J2EE application servers, they write their Java applications as Microservices that run on the grid. Applications are uploaded to the management platform, which regulates the way in which the individual Microservices making up the application are deployed to all the servers running containers.

Because the containers are lightweight JVMs, not large application servers, they can be installed on pre-existing machines. The failure-proof features of Service Grid work not only when servers fail, but also when server priorities change. The Service Grid management system will dynamically re-deploy those Microservices to other available resources.

In this way, Service Grid unlocks resources hiding in existing IT systems and puts them to use where they are needed most. These resources can be used to run new applications or to “pick up the slack” when other resources die. With Service Grid containers deployed on a number of servers, even undedicated ones, spread out in different locations and network segments, applications can be made invulnerable to failure.

This invention uses a service grid built on distributed agents. It uses characteristics of distributed object systems in the production of these agents. Rather than relying on heavy weight Applications Servers to host objects, The Service Grid relies on lightweight, remote deployable containers to host agent services. Rather that rely on web services for inter-service communication, this invention follows the more flexible Jini Network Technology model where services provide their communication process and protocol in shared proxy code which is distributed from the resource service to the consumer service. Web-services are implemented as one of many feature sets of this technological approach.

The service grid is a virtual association of Microservices and utilities interacting over networks. In order to allow seamless distribution, three parts of traditional applications software that are usually stored resident on the disk and memory of an application server (configuration information, bite code, and executable image) are made into independent items not resident or hard stored in the working computer. These three information representations of services are somewhat like phases in matter. Three main representations of services in the service grid include the configuration information in the Register, the byte code storage in the code server, and the deployed service in the container. See figures: “FIG. 3: Configuration Server for Service Grid”, “FIG. 4: Code server in a Service Grid”, and “FIG. 5: Distributed Applications Server in a Service Grid”; and their accompanying text.

Generally, the following components are available in the Service Grid (however, other implementations can make use of the described approaches to agent and object transfers between distinct processing domains):
Ecosystem: The entire distributed system of mobile services. The Service Grid. See FIG. 6: “Major Component Services” and FIG. 1 Thru FIG. 6.
Ecosystem Infrastructure: The physical grid: the distributed hosts (servers) and the network (VPN) over which communication between hosts occurs. The hosts support Ecosystem containers which support Microservice services; the network contains switches, routers, fiber, wires, circuits, routes, tunnels, and internet middleware.
Registry: (see FIG. 3) The repository of Ecosystem internal configuration data—configuration information is stored away from the hosts doing application processing. Configuration information includes all the server hosts, their IP address, and Kerberos security access. It also includes all the containers and services that will be maintained as ‘sticky services’ in the Ecosystem. With the services are the initialization data that they require. The Registry is often externally accessed as a LDAP (or UDDI) directory and internally accessed as a specialized Javaspace fronted by the Registry component interface. System wide configuration information is stored in XML format.
Code Servers: (Se FIG. 4) Code Servers contain binaries for services that run in the Ecosystem. This is maintained in JAR files. The Code Server is usually implemented as an HTTP server (Apache open source). Services are remote loaded from these into containers by reference to the URL of the JAR file. Alternatively, code servers can also be internally constructed as Javaspaces. These provide a powerful replication service using the Javaspace extensions or basic copying agents. A typical ecosystem will have several code servers dispersed in space. At least one code server is maintained per Domain.
Containers: (see FIG. 5) Containers are the major ‘heavy’ service, the cradle, in which all the Microservice run. These Containers are enhanced JVMs (Java Virtual Machines) which themselves are Jini services. They provide the local processing environment for the Microservice agents. Many services can run in a container; many containers can run on a host. All Ecosystem services reside in Containers when deployed.
Microservice: Any service that inherits the characteristics required to deploy in the Service Grid and built into the system for business goals (example: implements remote management interface). These follow a mobile agent pattern, but non-autonomous, without any itinerary subsection—that is these are mobile agents without self-mobility or ability to directly copy themselves. A pull model is used by Containers and by life-cycle agents to remotely deploy these services into Containers.
Utility services: Microservice that exists to provide resources to other Microservice—Utility services are tools that provide for business goals of code reuse and rapid development. Much of the structure of inter-service communication and interactions is embodied in utility services always present as sticky services. For instance the Grid Service Router.
Survivability services: Microservice that provide for lifecycle management of other services—several management agent patterns exist which will detect a failed service and restart that service—often in a different container. The Smart Reconnection Proxy that is inherited by all Microservice also enables survivability, as does the mobility provided by remote loading into containers.
Security services: Microservice that protect the system against unwanted intrusion, discovery of information, or software attacks. Complex webs of specific utility services utilize inherited characteristics bound into all Microservices. Some facilities are realized via external product such as the Jini version 2 secure RMI specification, multi-path certification, and Kerberos control of telnet agents. Some facility derives from structural characteristics of the ecosystem such as the fragmentation allowed by Microservices; the non-residency of code on servers and the difficulty in external discovery provided is the mobility of these services. Lastly there are propriety products such as the a Trusted 3rd Party encryption.

This invention specifically improves upon and extends these security features. It also improves upon inter-service communication.

### Supply Chain Prior Art

RFID systems today come in two flavors. Traditional RFID use proprietary tags and readers to identify stock, determine location from the reader placement and pass the (identity, location, time) data to Commercial Off the Shelf (COTS) business package software (often SAP or Manhattan Associates). All systems in use today are like this.

The second flavor comes from attempts to standardize the front end of the data capture and identification process. This standardization of the field is being supplied by the Auto-ID center, a collaboration of academics (MIT) and industry (retailers and technology suppliers.) The Auto-ID center has taken the approach of using RFID to enable an “internet of things”. They are adapting Internet middleware technology to provide this functionality. That code being developed, is a combination of Java scripts, adapted DNS and XML database code.
EPC —96 bit number with product class, vendor, and unique serial number
Readers (standardization) must discriminate tag read backs and coordinate turning on and off tags) Savant acts as a ‘data router’ capturing, filtering and forwarding the data
ONS (Object Name Server) that is adapted DNS server code. Takes EPC and finds home database for object assuming databases will be Internet reachable.
PML servers—store XML encoded info on product in PML markup language.

With Auto-ID, every RFID tag becomes a client. A reader system picks up product type, manufacturer, and serial number (EPC) and Savant connectors package this data as Events adding reader Id and location and the time the item was read. The Event is then routed through a series of filters and forwarding queues. During this process is it temporarily stored in an in-memory database and optionally passed to various logging and persistent data stores. Various Java scripts, launched by a Unix Cron derived task manager, can act on the Event. One such task will typically be looking up extended information about the tagged item via remote calls to the ONS and PML system. This request goes to an Object Naming Server (ONS), which is a modified DNS server. [DNS servers translate URLs to IP address so routers can route clients to specific servers connected to the Internet.] The query task takes the routing information from the ONS and places queries with either local or remote (manufacturer) PML databases, thereby establishing a local cache of basic unchanging data about the object. Another task allows data to be passed from the in-memory data and cache to external application systems generally via response to an external query. The information is stored in an external application database and reports are run to provide analysis and business functions.

The AutoId center is not concerned with updating information about objects as they pass through the supply chain. It is not concerned with automation of business processes where items are read. This system simply packages tag reads as events, associates these with basic manufacturer data, and makes this information available to external business applications. (See FIG. 21: Prior Art for RFID Middleware.)

While the reader to event identification software from the Auto-ID organization is patterned on existing Internet-middleware services, open source databases, and Unix-like utilities, effectively, this approach just dumps event data into near-obsolete client server architecture of the 90's. To be used the reader data must first be filtered (whereby most data is discarded) and then end up transported into massive database systems that can deal with the millions and eventually trillions of data triplets (identity, place, time) coming from throughout the supply chain. All the business logic is remote from the physical device that was tagged.

Shortfalls of the Current Savant Architectural Definition:
Large reliance on filtering data out to handle scale. Since the result is ‘digestible chunks of information’ for heritage supply chain applications, data is winnowed down and transformed.
Potentially important information is thrown away, never to be recovered.
This assumes one can accurately predict, at the point of installation, all the stuff you will ever need to know in the future.
Because filtering decisions determine how many servers to deploy, how to deploy them, and how they will report up to each other in the Savant hub-and-spoke scaling model, a simple decision to make more data available to an ERP/procurement/warehousing program can require redesigning the entire Savant architecture.
Savant is directly dependent on OS for application platform. Modern systems use application server technology like J2EE or distributed service systems like Jini and NET. Enormous gains in programmer productivity result. Savant is not a service or component system, but instead an amalgam of compiled and script programs strung together by an adaptation of UNIX scheduling programs. No use of naming and registry services or advanced service discovery.
No built-in management model. No ability to monitor or query components on their health.
Savant uses a push model for process realization that is complex, hard to design, balance and implement. Message flows can break. Modern systems use pull methods or async/parallel communications. Much simpler to design and more reliable.
No security model built into the architecture of Savant.
Security actions can be added, but they are band-aids on system components well-known to hackers.
Authorization and authentication must be “wrapped-around” fundamentally insecure models of data-sharing in order to communicate with supply-chain partners

While the traditional & competitive technical approach is solid, it is not as advanced, flexible, reliable, and securable as future RFID applications demand. For instance:
The traditional approach to security is to develop a comprehensive new “protocol”. In general this is the mainstream approach. It is a place where the Service Grid and other are strongly differentiated. We use services, specifically mobile services, instead of protocols. This allows for general and specific solutions that are easily changeable and can scale better.
These traditionalists do not have a concept of moving the intelligence from the central enterprise out close to the device. For them brains are in the center which has good communications with the edge. Service grid and other agent approaches move intelligence close to devices.
Where the reader agent is connected to central processor, deployment is simply hub and spoke; a model which does not scale to global deployments. For Service Grid, deployment is globally dispersed services in an N×N redundant computing grid, with an inbuilt concept of regional domains.

It is now widely acknowledged in current trade journals that the Savant approach did not draw upon contemporary distributed computing techniques.

In the prior patent application, “Ser. No. 10/913,887—System and Method for Use of Mobile Policy Agents and Local Services, Within a Geographically Distributed Service Grid, To Provide Greater Security via Local Intelligence and Life-Cycle Management for RFID Tagged Items”, the applicant described a new solution for supply chain automation and RFID data collection based on use of the Service Grid and specific agent architectures. This earlier application presented an open trust model where participants allowed free movement of agents within a shared Service Grid. This assumption of an open trust model is not likely to be universally accepted. The current application describes improvements to the actions of the prior RFID agent application such that this approach will function in heterogeneous technical environments and in restrained trust models.

What Clearly is Needed are Advanced Security Features that Support Rigorous Homeland Security Directives in the Supply-Chain:
Non-repudiation of transactions at the message and service layers, so that event delivery and processes are secure from failure.
Encryption of data regarding product information and users
Encryption and safeguarding of processes so that these stay secret as needed (requires object representations of these).
Authentication of all external touch points: users, databases, ISV software, etc., both actively (AAA) and passively (e.g., intrusion detection systems, sanity checking). Ideally, this is linked to easy-to-manage policy-based permissions and Access-Control-Lists (ACLs).
Accounting and secure logging of all system changes and significant events. Ability to correlate this with specific system and user actions.
High-availability/Backup systems to recover from hardware or other failures. More ideal, of course, are Survivable Systems, which are proof against all accidental and deliberate attacks, from component failures, to power outages, to explosions in data centers.
Integration of reader device management and data collections coupled with fraud detection systems, so that breaking or tampering with a reader does not allow theft or product tampering.
   Architectural Components Emerging as Necessary for Advanced Middleware Systems:
Communications layer: early generation systems use API messaging (IIOP, RPC), mid generation systems use publish & subscribe, late generation systems use RMI, net remoting, and space-based computing.
Naming, registry and discovery services allow services to interact and be managed individually and as a whole. Jini lookup and UDDI are replacing LDAP directories that, in turn, replaced object brokers (ORBS).
Grid-like server platforms are replacing multi-processor server clusters
Process control via workflow is being superseded by policy directed behaviorist systems.
Distributed transactions and distributed data storage across multiple databases, SANS or like are replacing monolithic transactions layers.
Device-independent user access via wireless and location services is replacing consoles and message pagers.
Built-in management systems with management APIs in all service components. Ultimately this allows for self-healing systems.

A fundamental departure from existing practices is the introduction of a notion of ‘intercommunicating services’ rather than ‘protocols between servers.’ This idea has been most effectively expressed by the Jini development community and was fundamental in the architecture and design of the Jini Network Architecture. Basically, a service can find and download the remote interface of another service. This interface can provide the methods and the protocols for communication between the services.

Basically standardizing protocols, getting them correct and getting them agreed to is a long and costly process. It always falls behind technical ability. With the service approach, this standardization of protocol is unnecessary. All you need is agreement on the structure of information and methods between the two services. Every service in the common grid can adapt and evolve as fast as communication methods are invented—incorporating these advances within updated communication proxies which are propagated via code loads as the services are deployed.

The basic idea behind the prior referenced RFID agent is simple. Because of economics, RFID tags must be small, simple, and conservative of power. This limits the data that can be contained on the tag and the ability to write fresh information to the tag. The RFID agent is a virtual business object that is linked to the RFID tag via the specific identity code that is written to the tag. All the information that world be useful to have at hand, but cannot be stored on the tag, is written into the RFID agent.

Besides the manufacturing data (typically makeup, composition, lot numbers, delivery instructions) that is stored in the RFID agent, the agent can also store policy in the form of rules (event, condition, action statements). The agent subscribes to events and reacts according to the instructions in the rules whenever it receives a triggering event.

The RFID agent moves about in the supply chain following the tagged item. (See FIG. 12: RFID agent follows tagged item through supply-chain). Whenever a read of the tagged item occurs, the RFID agent discovers this and locates into the closest free resource container in the system. As the tagged item moves about in the supply chain, new data is added to the RFID agent so that it contains a complete history of the item.

The Supply Chain is a naturally distributed environment—in fact it is often called the distribution channel. Goods travel from point to point across geographic distances. There are diverse origins of these goods, transshipment and storage locations and many pooling points and fragmentation events in the life cycle of their economic usefulness. At each of these locations or transit channels, events can occur which have significance to the valuation and subsequent handling of these goods. An ideal system would capture not just the route taken by these goods, but all the events that occur during this movement in the value chain. (See FIG. 10: Supply-chain is naturally, physically distributed).

Supply chain automation has a basic requirement of tracking and capturing all these events as they occur and making this information available to downstream systems that are making business decisions on treatment of these goods.

Existing approaches attempt to fit a pre-existing image of what IT resource deployments should be or actually are, to the dispersed nature of the supply chain. These existing images are driven by Enterprise Resource Processing (ERP) which, given existing IT technology of the nineties, found centralized data centers the most cost effective IT deployment model. Therefore data capture programs (or agents) are placed at the physical nodes of the supply chain and a network must be used to transfer the data collected back to a centralized data center for processing. This approach results in:
Delays from network transmission
Subjects decisions and information to the unreliable nature of networks
Necessitates a central organization of data structures which may not be that of the local data capture points, requiring translations and re-segmentation of data
Favors centralized reporting as the tool for analysis and work flow as a means of reacting to data

However, studies and field trials have found that automation is best realized by event-driven systems that utilize policy to implement process, and not work-flow. Policy has also been effective in solving complex routing requirements in very large networks. Adapting centralized systems to react to events and to use policy and rules (event, condition, action statements) have proven problematical and expensive. Getting central decisions back to the localized sources, ironically, is itself an IT data distribution problem.

Utilizing the unique characteristics of the Service Grid, mobile software agents can relocate in close proximity to RFID tagged items. Once associated with the tag, these agents are pulled near to the read and provide local control, environmentally responsive policy, and permanent data capture & history.

The basic idea behind the RFID agent is simple. Because of economics, RFID tags must be small, simple, and conservative of power—and at best, externally powered. This limits the data that can be contained on the tag and the ability to write fresh information to the tag. The Vendor's RFID agent is a virtual business object that is linked to the RFID tag via the specific identity code that is written to the tag. All the information that world be useful to have at hand, but cannot be stored on the tag, is written into the RFID agent.

Besides the manufacturing data (typically makeup, composition, lot numbers, delivery instructions) that is stored in the RFID agent, the agent can also store policy in the form of rules (event, condition, action statements). The agent subscribes to events and reacts according to the instructions in the rules whenever it receives a triggering event.

The RFID agent moves about in the supply chain following the tagged item. Whenever a read of the tagged item occurs, the RFID agent learns of this and locates into the closest free resource container in the Service Grid system. As the tagged item moves about in the supply chain, new data is added to the RFID agent so that it contains a complete history of the item. All relevant information about a physical item, which will have an RFID tag attached, is stored as data in this mobile agent service. This includes, but is not limited to:
Type of item, family classification of item and uses
Serial number
Manufacturing lot numbers
Creation place and date
Composition
Assignment or ownership

This agent also contains event, condition, action (ECA) statements that embody policy for the item including but not limited to:
Liability polices
Environmental policies
Handling instructions
RMA treatment
Disposal instructions

The virtualization can contain links to service level agreements that cover the item.

As the item moves through its life cycle, more information is added to the virtualization agent. Some of this is data such as:
Location-time history
Environmental factors history
Damages and repairs
Ownership or responsible body transfers
   Other information added can include new or changed policies.

Specific details of agent exchange between partners using the prior application art are explained in FIG. 13 and the accompanying description. (See FIG. 13: Prior application—Service Grid Ellipsis RFID Agent Movement).

Agent movement in a Service Grid allows a unique benefit when it is deployed across cooperating partners in a supply chain. When partners deploy this same approach they are able to share sophisticated policy data regarding inventory that is simply impossible with any other system. Refined knowledge and policy gained at one location can be passed along to other supply-chain participants. This creates a powerful incentive to share the system with trading partners.

Basically, the RFID Agent collects and stores detailed data as it moves along. Partners downstream in the supply chain can utilize the additional data provided by earlier transit points. If an Return Merchandise Authorization (RMA) is ever invoked, or the item need repair, originating supply chain members can gain access to vital history of transit and use data from the RFID agent.

The RFID Agent can also store policy. This behavioral and reaction information also provides value as it moves downstream in the supply chain. Manufactures can add information about how to treat the item under environmental changes. The RFID Agent is extensible and new policy and state information can be added in downstream supply chain participants. Distribution partners can add policy, that might for example, send an automatic tracking event, triggered when the item departs a regional warehouse, so that upstream suppliers can know to replenish the item.

But this potential value must be tempered with proper security considerations so that all supply chain participants can gain the benefit they desire without compromising integrity. The normal value chain sharing a service grid must be understood to be a ‘trusted’ system where everyone plays by known accepted rules. RFID-agents entering a users community must be allowed to depart with the information they have gained. That is, a user generally should not restrict information about where the item was warehoused and any environmental conditions that might have been recorded for that location. This is called a Full Trust environment. Strong advantages exist when standard Service Grid service/container security is allowed to govern transit of services across organization boundaries. Far from frictionless, such a normal transit would still involve secure validation of the foreign derived service before the container will allow it to load and execute. In addition the local container will enforce an accounting transaction to be logged that provides a record that the service deployed in this specific container for this specific time.

However, practical real world environments are heterogeneous. Also trading partners may not wish to share all information. In some circumstances there may be conflicts with the information a trading partner may wish to share and the information a downstream partner (or consumer) needs. This may eventually require intervention of regulatory agencies or other consumer watch dogs. Alternatively, when the data influences the integrity of the item (like perishable food), the manufacturer may contractually require this information be captured and passed as part of exchange contracts.

The present invention provides a technical solution that allows passage of RFID agents (and other policy/data agents) between partners which are not complexly open in common trust and where some collected information is maintained as private (such as internal cost data and employee IDs during inspection processes) and not transferred.

### SUMMARY OF THE INVENTION

The present invention is directed to a system, method, and software implemented system of services for providing enhanced security and management to multiple domain grids and allowing intercommunications between the different grid domains. The present invention provides for data exchange, policy exchange, and agent exchange between grids or grid domains.

Examples are described showing the internals of gateways, the registration of gateways with enterprise lookups, the discovery and binding of remote gateways, the discovery of gateway pairs by local domain services, the secure, filtered transfer if policy (Event, Condition Action statements) and data from one domain to another, the securing of agent code through use of a local, authenticated code server, and the assembling of completed transfers of agents from policy/data kernels and the local agent code.

Simple gateway to gateway transfers are shown as well as associations of multiple gateways. Also show is interconnection with non service grid domains via heritage protocols.

Also, via the exemplary example of the above, the present invention describes providing enhanced security and management to supply chains: providing data exchange, policy exchange, and agent exchange between supply chain nodes and supply chain partners—specifically when technical environments are heterogeneous, different policy and security domains are present, and trust models are not identical. Examples show how this invention facilitates enhanced methods of supply chain automation when using barcodes and RFID tags to identify and track goods through supply chains and consumer uses.

This invention aids homeland security efforts by facilitating recording of information about moment of goods through supply chains. It also provides for secure information transfers between different government grids and security policy domains.

### DESCRIPTION OF THE DRAWINGS

FIG. 1: “Contrasting Service Grids to other Grids” is a layer diagram comparing several current classes of grids, showing the facilities they generally provide at each layer.

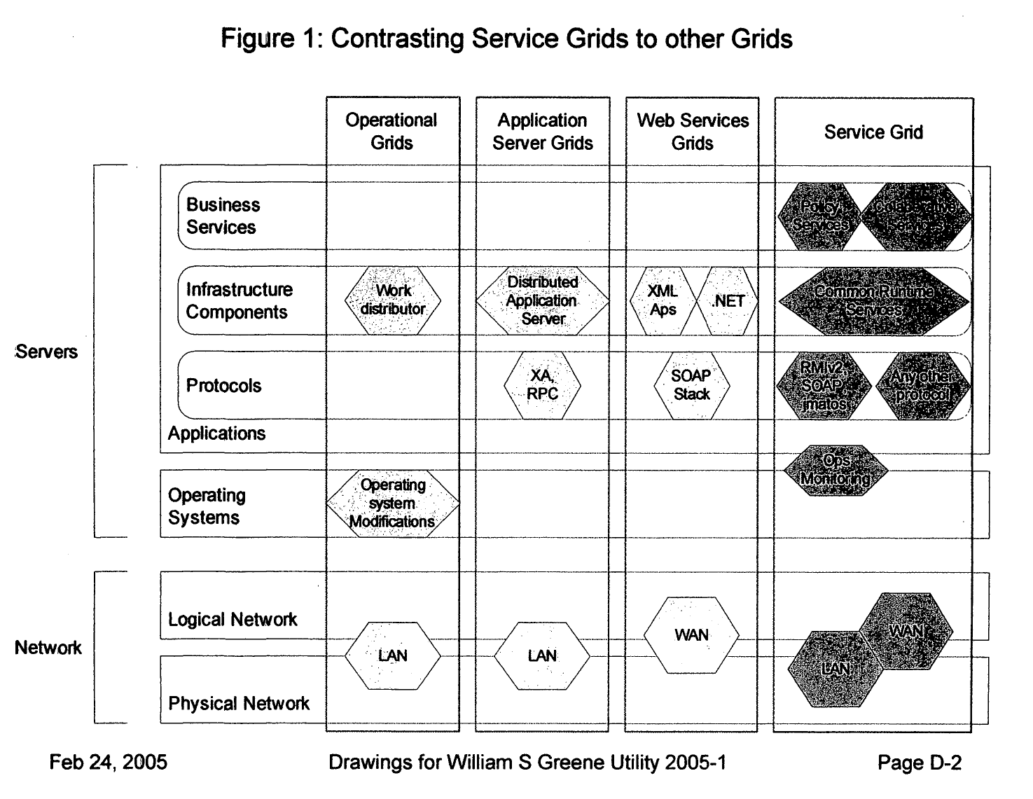

FIG. 2: “Architecture Schematic for Service Grid” is an architecture diagram showing the virtual and physical parts of a Service Grid. The Service Grid is a collection of services deployed on a network of distributed computers. The virtual/software part: Business and Utility services are shown in containers above. (Containers are drawn as open boxes, Business services are represented by cylinders, utility services by shapes which are consistently used throughout this and the referenced applications.) The physical grid of computers and network is shown below. The containers run in computers everywhere in the grid networked into domains via LANs and across domains via WANs. The Service Grid is usually deployed over a wide geographical region for security and survivability characteristics; but can be grouped as desired. The enterprise domain generally contains administrative services (such as the global register) and services involved with inter-domain coordination, including certain persistence and process services. Thousands of computers and tens-of-thousands of services can participate in the grid allowing scaling to supercomputer equivalent processing levels.

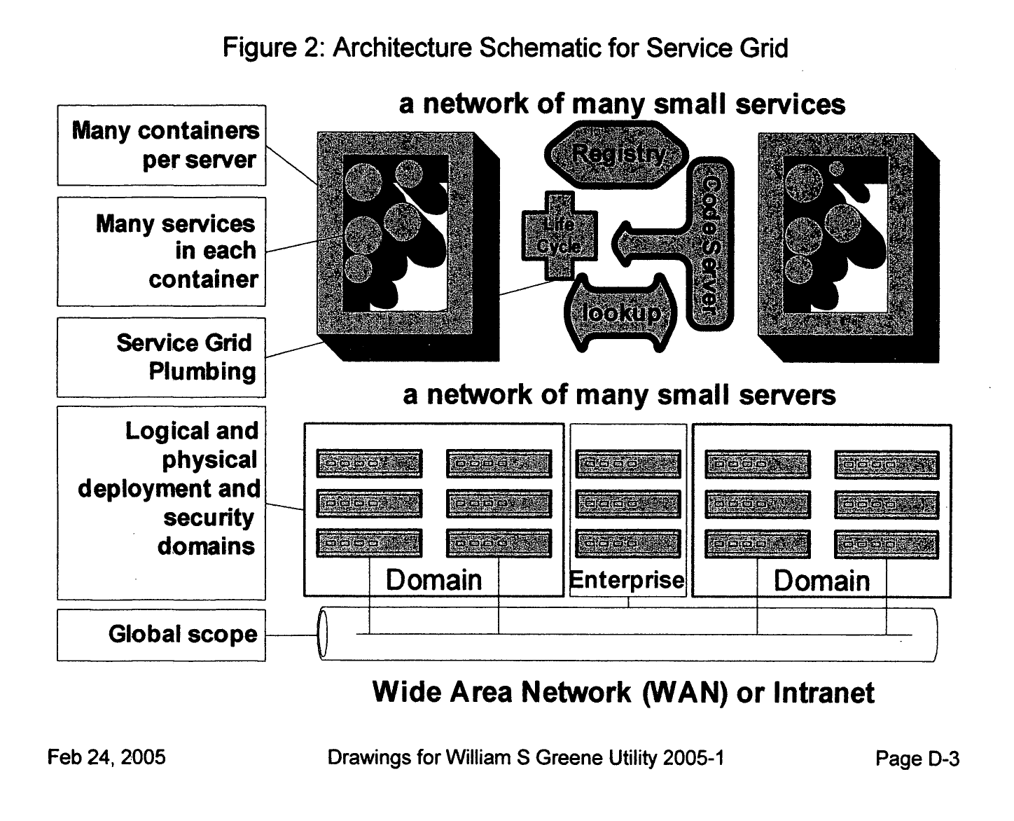

FIG. 3: “Configuration Server for Service Grid” is an architectural layer diagram showing the storage of services information in the Registry. In the exemplary example of a service grid an LDAP directory is used to provide persistence and query facilities for this information which is stored in the nodes as XML encoded strings. In addition the structure of the network is maintained as a hierarchy of domains and servers linked to domains in notations similar to LDAP standard uses for encoding network information. A directory is used because the tree organizational structure of a directory is a natural way of representing the hierarchical information of services in logical domains and servers in network domains.

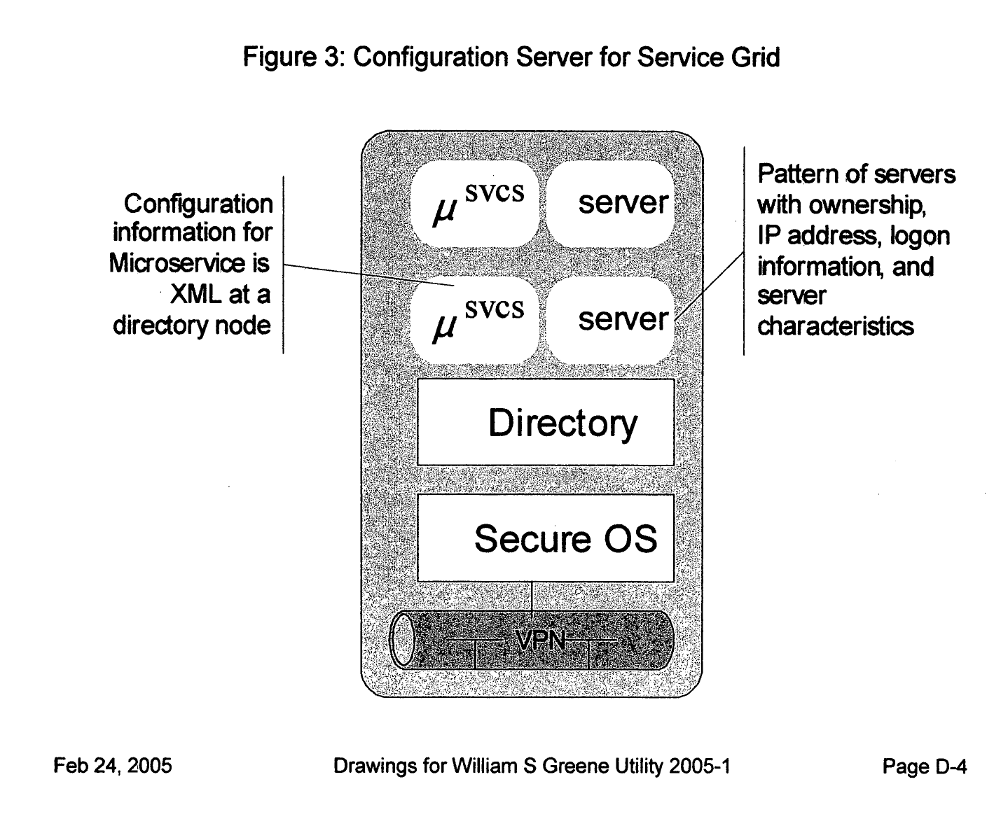

FIG. 4: “Code server in a Service Grid” is an architectural layer diagram showing the storage of services information as bite code in the code server. The practice of organizing Java code in JAR files and storing these as elements in an HTTP server (such as Apache) is becoming a common practice in java distributed systems. The code is deployed on external request using HTTP protocols from the code server to the requesting server (much like text and pictures are deployed from web servers into browsers.)

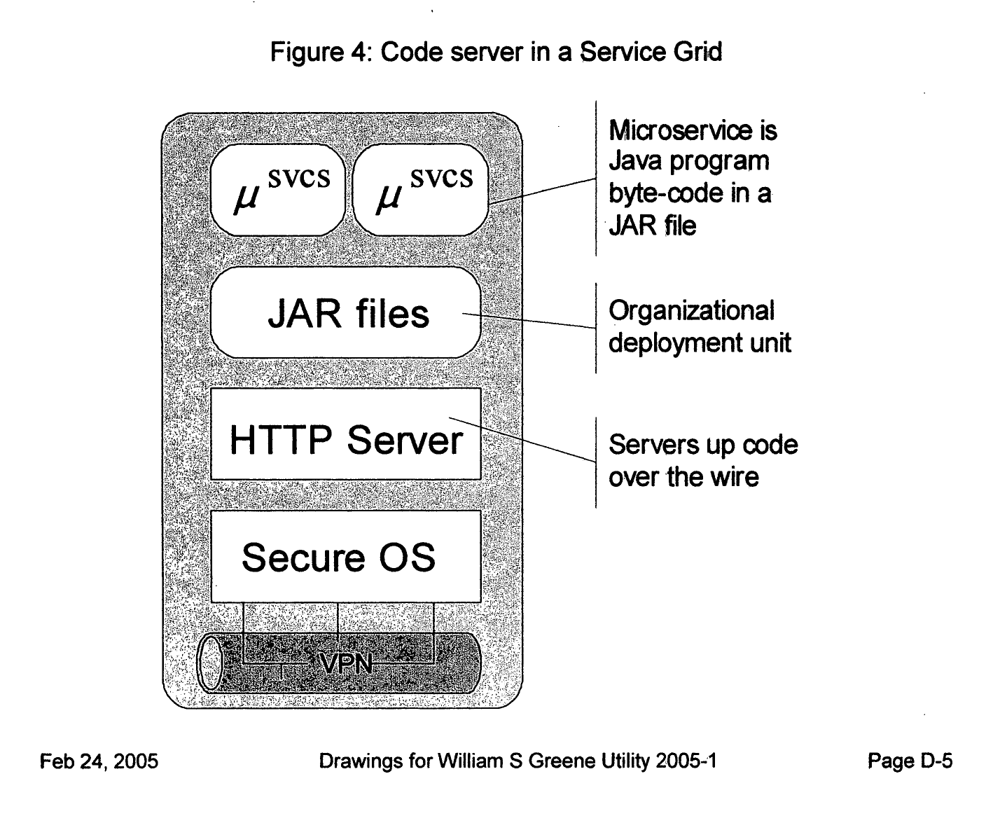

FIG. 5: “Distributed Applications Server in a Service Grid” is an architectural layer diagram showing the deployment of services as executable code in a container on a service grid working applications server. Rectangular blocks represent 130S controlled services; those outside the sandbox of the container. Rounded blocks represent Microservices; those inside the sandbox container. The OS controls Jini services (or dotNET services) and the containers themselves—these are often called heavy-services. For secure operations, a secure OS is loaded at the time of installation of the servers and then linked to a multi-path Kerberos agent; henceforth only interactions with the OS can occur remotely via logging into the Kerberos agent. Also this limits and specifically names the heavy services which are allowed to run on this server. A life cycle agent interacts with the Kerberos server to bring up containers according to the deployment information in the configuration server Registry. Multiple containers can exist on the server. Microservices deploy into the containers via feeds from code servers.

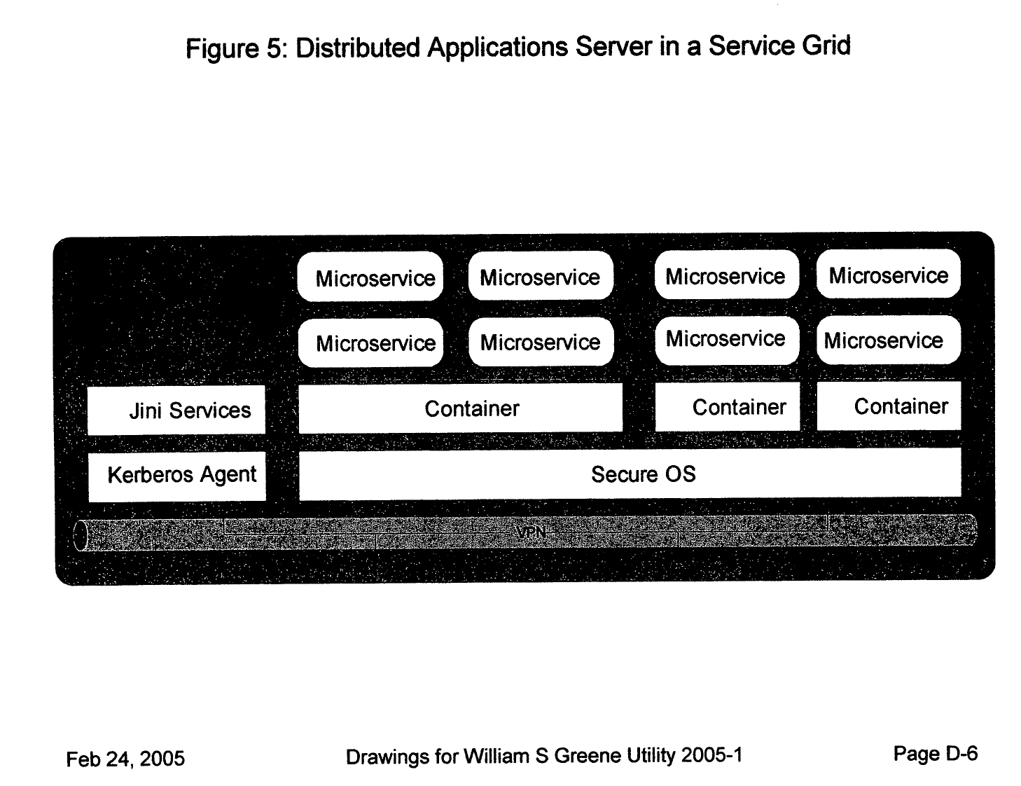

FIG. 6: “Service Grid showing representative components” is an architecture diagram showing the association of major service groups (components) into application templates. Rectangular blocks represent OS controlled services; those outside the sandbox of the container. Rounded blocks represent Microservices; those inside the sandbox container. These components are briefly described in the specification prior art. Of specific note here is the gateway template. This is the starting point for the secure policy gateways described as a novel improvement in this applications. However, several other service groups, such as the administrative services, utility services, and distributed data services, are used as well.

FIG. 7: “Service grid in two separate domains—only policy & data are exchanged” is a logical application layer diagram of two separate domains (or corporate deployments). At the lowest level are the core services and templates (the components from FIG. 6 and the patterns used in assembling services into applications). Above this is a set of business polices, procedures and data which is shared among most domains and was usually distributed as part of the original service grid product. Above this is a set of business polices, procedures and data which is generally agreed to and shared in common among the industries which are cooperating. This has generally been developed as a vertical industry product or through standards organizations and business associations that the separate corporations partake in. Again this block of services will be substantially identical among the sharing domains. Above this are policies, procedures and data developed by the individual domain members. This group is likely to be substantially unique per domain. Security policies, processes and data specific to the domain/corporation reside here. The information which is shared between service grid domains is isolated into specific Policy Microservices, of which there may be a large but discrete number. The novelty of this invention application is concerned with the filtering and selection of the policy and data to be exchanged, the transmission via an agent or other data representation, and the acceptance and deployment in the receiving domain of this information. It is assumed that one or many security barriers exist between the two domains.

FIG. 8: “Prior art in information transfers—web services” is an architectural flow diagram showing the current “best practice” in the exchange of information between different security domains or corporate boundaries. Idealistically, two different web service gateways can exchange XML data-grams via SOAP protocols running over HTTP utilizing the “hole” placed in firewalls for web surfing. In actuality, different web service gateways rarely can directly interconnect and this data-gram exchange is not secure; therefore, a number of secure, managed web service products exist to correct this. Generally the same vendors product must be placed on each side of the exchange because proprietary methods are used to secure the information and provide reliable data-gram transfer. Several methods are used to link the web service gateways to the information to be transferred (APIs to the heritage applications, direct linkage to databases, or interconnection via message (pub sub, message brokers or JMS) applications. XML data-grams do not easily allow more than data to be exchanged and it is assumed that policies and procedures are separate and private on each side of the transfer. Therefore separate and agreed to procedures generally govern these transfers, but no automated mechanism exists to exchange these between partners.

FIG. 9: “Prior art—transfer of information via EDI-INT (v1 or v2)” is an architectural flow diagram showing the current “dominate practice” in the exchange of information between different supply chain partners. This exchange using SMTP and MIME is sometimes considered inferior to the web service approach and therefore, version 2 of the IETF standard for EDI-INT uses a similar XML encoding of data but still relies on SMTP and MIME which is generally more reliable in transfer than SOAP/HTTP. Generally these specialized mail gateways attach to applications via custom APIs. MIME mail messages do not easily allow more than data to be exchanged and it is assumed that policies and procedures are separate and private on each side of the transfer. Therefore separate and agreed to procedures generally govern these transfers, but no automated mechanism exists to exchange these between partners.

FIG. 10: “Supply-chain is naturally, physically distributed” is a cartoon illustration of a simplified supply chain. Flow moves left to right during the life-cycle of goods in outward distribution. Supply chains are geographically dispersed, often global in scope. They are not usually connected by common networks. No easily predicted path exists during the real world transit of goods where environmental and work conditions are constantly changing. Current art is to predict the flow of goods for purpose of optimizing routes and then using business processes that are at arms length to direct this flow. Often the transport processes at the edge are not automated. This invention leverages an architectural solution to the physically distributed supply chain of a physically and logically distributed business services grid, placing that grid throughout the supply chain. This invention covers circumstances where there is incomplete trust between supply chain nodes and partners, a likely occurrence in today's global supply chains. It also addresses when different versions of the service grid or even different product technologies are present in different domains.

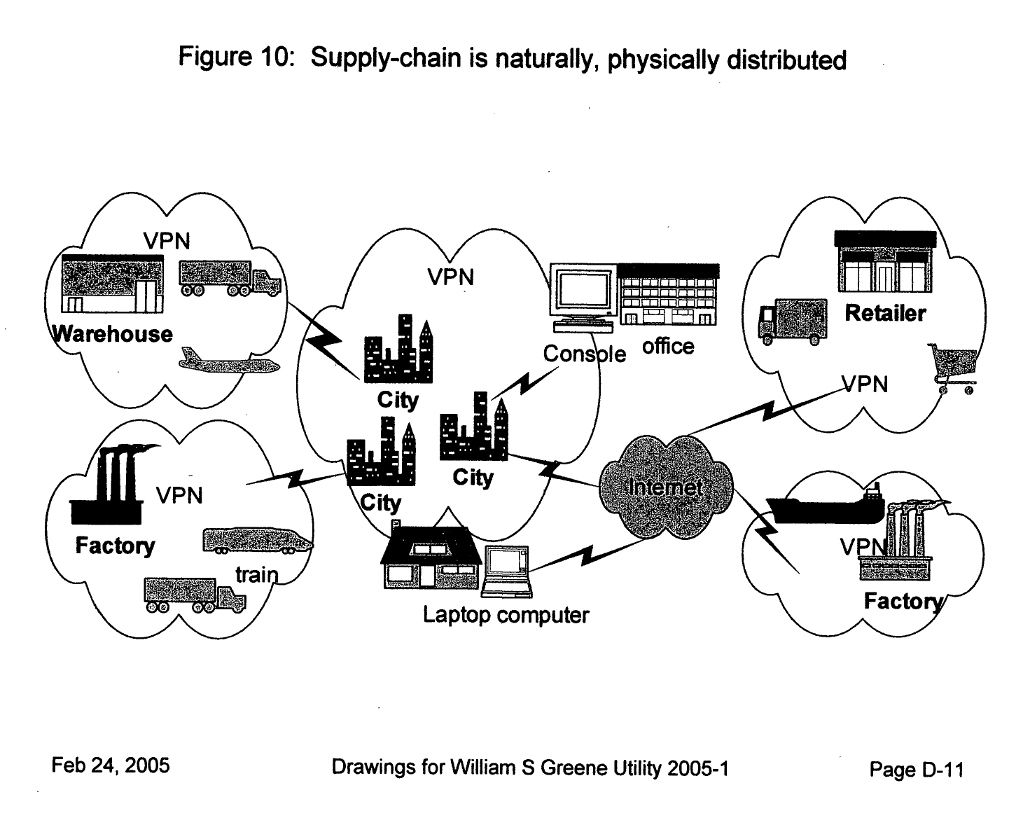

FIG. 11: “Prior Art for RFID Middleware” is a flow diagram showing 3 views of prior art in RFID middleware. The top view presents the information flow around reading an RFID tag as envisioned in the idealistic Auto-ID center's “Internet of things”. In the middle view, this idealistic view is being replaced in actual implementations by a practical integration of the supply-chain methods in practice for barcodes with the reader-side features of the Auto-ID architecture. The bottom view highlights the requirements for integrating a mime-mail transported EDI manifest with the information from a tag read as an added burden on RFID middleware systems. In market practice, the heritage supply-chain products are extending themselves with satellite edge servers which just read and verify, passing the information back to the ERP structured heritage product core which retains all the business process computation. These methods are all inefficient and restrict supply chain automation and integration.

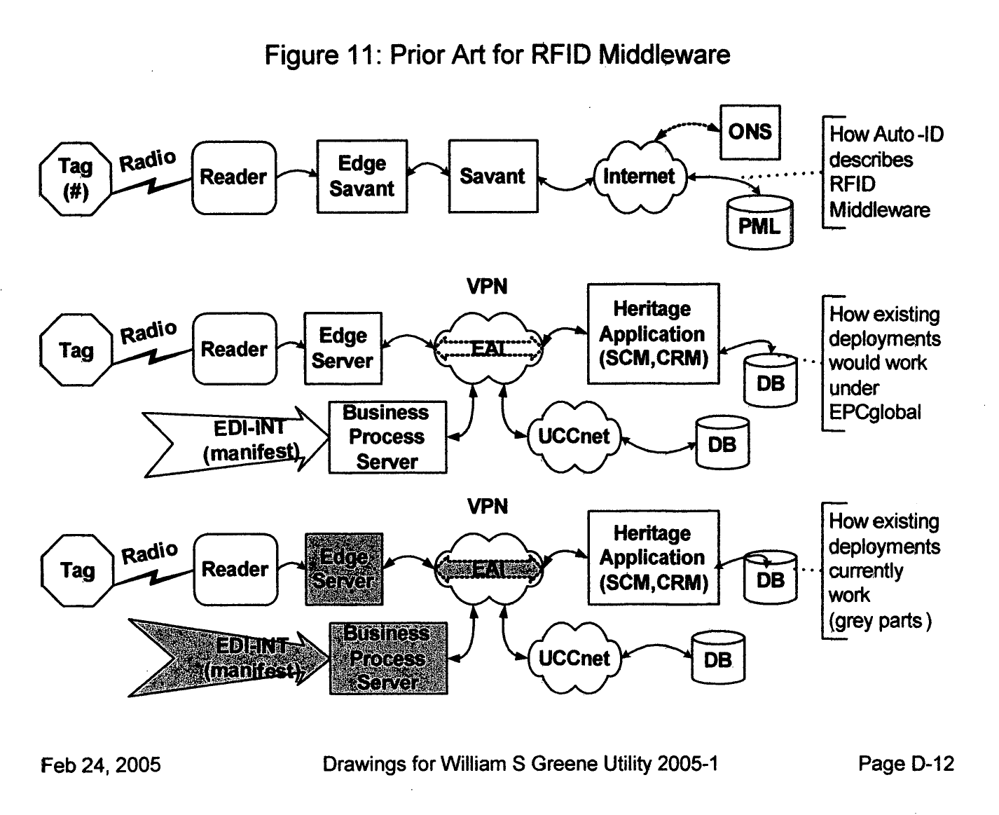

FIG. 12: “Agent follows tagged item via tag ID from domain to domain” is a flow diagram that presents a cartoon of the RFID agent moving with the RFID tagged package item. Instead of gathering reader data (Id, time, location) and shipping it back to massive, centralized, ERP supply-chain applications, the information is bundled into an agent which moves with the tagged good; following in the virtual space of the service grid. The agent associates with tagged item via tag ID as read by RFID reader. For the mobile agent approach to function properly there needs to be an association of the ID in the RFID tag with the name of the agent. The past invention uses XRI in the agent for this. There also needs to be a business Service Grid which involves computers placed where the tagged item will travel and a network that connects these locations. The RFID readers in the supply-chain locations will connect with the local computers which are a part of the service grid.

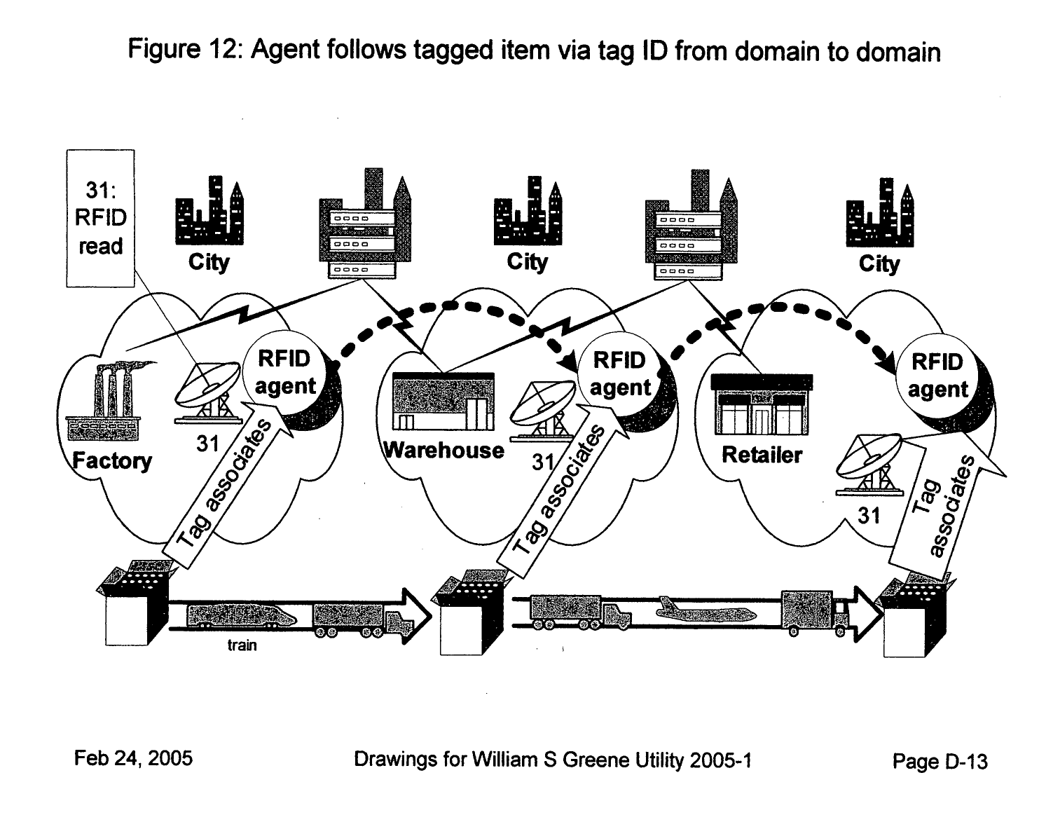

FIG. 13: “Prior application—Service Grid Ellipsis RFID Agent Movement” is a functional diagram of the process of RFID agent mobility. This is an RFID specialized version of the more general case of the ‘movement’ of any Microservice. While an RFID tagged item is physically transported from down or up the supply-chain (shown at bottom), the RFID agent relocates from the Ellipsis domain of the item source location to the Ellipsis domain of the item receiver location. The agent does not actually move itself as in prior mobile agent art. Here the agent interacts with a 3rd party authentication service (Agent-Avatar) to broker the apparent movement. Actually the soft information (data & policy) is copied from the source RFID agent up to the enterprise and persisted. After authentication, the Agent Avatar invokes the production of a fresh RFID instance of the correct type is manufactured by a factory in the receiver domain. This links with the Agent-Avatar and downloads the soft information for the specific instance. This has the effect of cloning the RFID agent from source to receiver but adds the security functionality of the Service Grid. When cloning is verified as complete, the original RFID agent in the source domain is killed and garbage collected. Generally, when a specific or general itinerary is known (externally or embedded in the RFID agent), this cloning will occur before the physical RFID tagged item gets to the receiver location. The RFID agent clones, attaches to the local Ellipsis tuple-space and waits on the arrival of the RFID tagged item—speeding processing. If multiple destinations are possible, multiple copies of the RFID agent can be cloned to each location. On arrival of the RFID tagged item in one location, the other clones are killed at the same time and with the source original RFID agent (generally under control of a distributed service transaction.) The Agent-Avatar with persistence services, also acts as a backup for restoration of the RFID agent in the event of service disruptions. Novelties in this invention improve upon this processes when the agent transfer must occur over non-homogeneous security domains or across partners with different trust models.

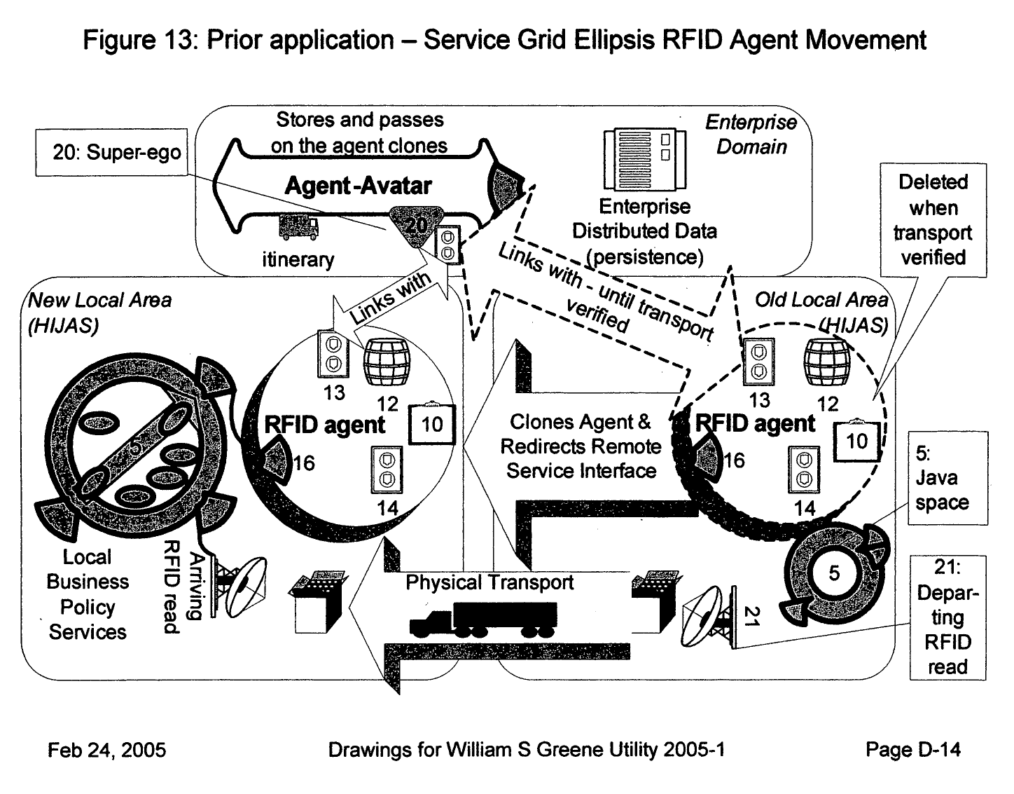

FIG. 14: “Prior application—Schematic of Policy Agent” is a schematic illustration of the production of a Policy Agent from the core of a Microservice. Specifically designed to be built with Rapid Application Development methodology, the kernel is a group of Event-Condition-Action (ECA) statements, a specific way of representing rules for policy. The kernel has an internal, local interface to the mobile agent. The agent has a generic policy interface which other services can discover and invoke using either interface-template matching or meta-language XML/XRI. Prior art has behavior services implemented as a heavy-duty remote service, often a rules engine comprising thousands of rules or even worse as undifferentiated business logic embedded throughout heritage programs. It is extremely facilitating to have the rules dispersed where they can be invoked via service discovery.

FIG. 15: “Policy Exchanging Gateways” is an architectural flow diagram depicting the transfer of a policy Microservice (the egg representation) from one domain to a separate domain under conditions of limited/negotiated trust.

FIG. 16: “Gateway Discovery and Policy Transfer” is an architectural flow diagram depicting the process for gateways registering with an enterprise lookup service. Also shown are the discovery of a receiving gateway by a transmitting gateway, the binding of transfer policy, Service Transfer Agreement (STA) services, and the remote binding of the two gateways prior to policy transfer.

FIG. 17: “Multiple Exchange Gateways” is an architecture diagram showing that one receiver gateway can bind to many transmission gateways. Each is bound via downloading the remote proxy to the transmission gateway from an enterprise lookup and then invoking the remote binding via that proxy and also the assembling the relevant locally defined STA services. Gateways are frequently built from Javaspace cores using agent templates similar to the HIJAS subsystem in the prior referenced patent application; and as such STA services usually inherit from the Javaspace agent generic service. Simple gateways can be built as service-to-service communities bound and controlled by Aggregators.

FIG. 18: “Use of gateways when different technologies exist in the domains” is an architecture diagram showing that one receiver gateway can bind to many transmission gateways with different technologies from the Service Grid. Each foreign gateway has a protocol connector agent loaded for that specific communication type which binds to the space inside the Service Grid Receiver Gateway. Each foreign application (T1 & T2) will have a data translator service and protocol controller (communication translators which are built from state-machine agents) service that also bind to the internal space. Messages from the Transmitter gateways pass through the protocol binding service into the Space where they become space Entries. Translators and Protocol controllers which have registered with the space for this message type fetch these from the space and process them. Messages passed into the space from the service grid business process responder services also manifest internal to the state machine as Entries and are processed by the translator, the protocol controller and than the protocol binding agent from which they are transmitted to the foreign gateway. Remote Service Grid Transmitter Gateways (TG3) function by passing the “yoke” of data & policy into an entry, which is then processed by a Service Trade Agreement Service and then is assembled by a factory (binding to the space) with code fetched from the receiver code server into a local Policy Agent.

FIG. 19: “Deconstruction is used to design reusable services for the Service Grid” is a stepwise transition architecture cartoon that shows how existing applications can be broken into parts: common plumbing, common business elements and unique expressions of data and policy. This process is used when converting from existing transmission gateway applications such as shown in FIGS. 8 and 9 to the novel service architectures in this application. This model, by decomposition, comparison, and normalization, allows policies, gateways and STA services to be extracted and re-engineered from existing message exchange applications.

### DETAILED DESCRIPTION OF THE INVENTION

(See also text accompanying description of the figures in section 5 of this application and the figures attached.)

### Functioning of a Policy Agent Transfer Gateway

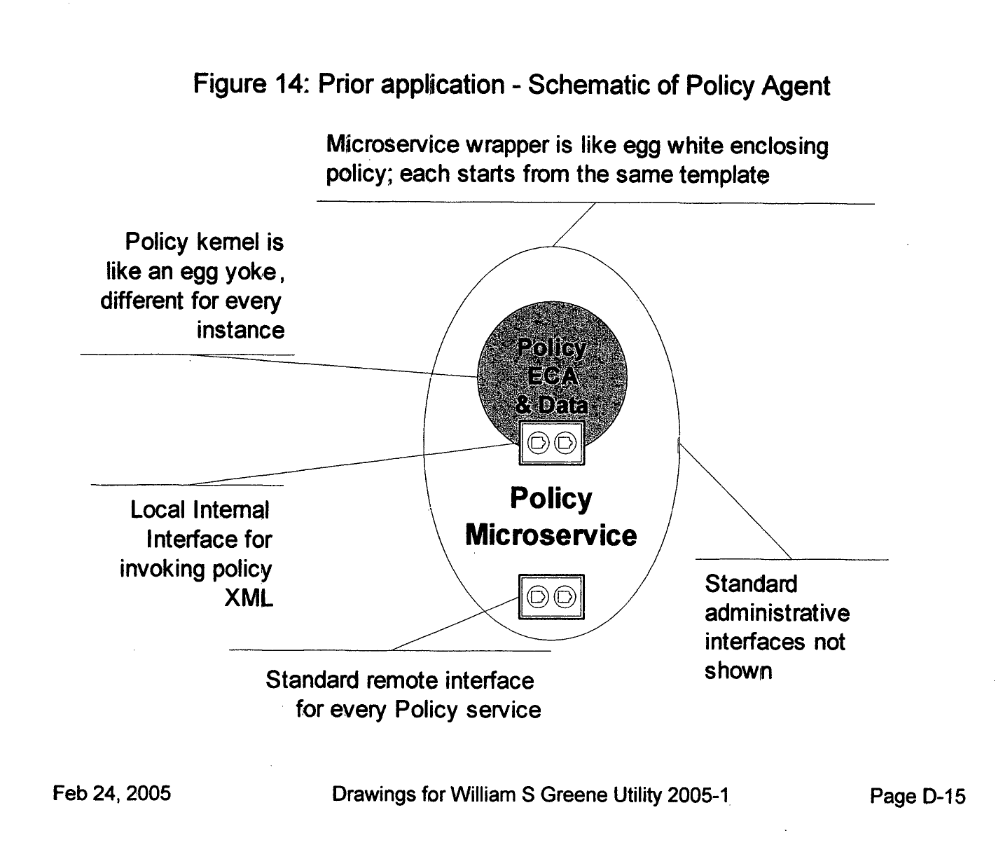

Policy Agents were originally described in the prior referenced application: co-pending U.S. patent application “Ser. No. 10/913,887—System and Method for Use of Mobile Policy Agents and Local Services, Within a Geographically Distributed Service Grid, To Provide Greater Security via Local Intelligence and Life-Cycle Management for RFID Tagged Items”. FIG. 14: “Prior application—Schematic of Policy Agent” is a schematic illustration of the production of a Policy Agent from the core of a Microservice. Specifically designed to be built with Rapid Application Development methodology, the kernel (illustrated as a yoke in an egg) is a group of Event-Condition-Action (ECA) statements, a specific way of representing rules for policy. The kernel has an internal, local interface to the mobile agent (illustrated as the egg white). The agent has a generic policy interface which other services can discover and invoke using either interface-template matching or meta-language XML/XRI. Prior art has behavior services implemented as a heavy-duty remote service, often a rules engine comprising thousands of rules or even worse as undifferentiated business logic embedded throughout heritage programs. It is extremely facilitating to have the rules dispersed where they can be invoked via service discovery.

This application departs from and augments the prior referenced application by considering a heterogeneous group of implementation domains which will generally have different security considerations. These domains could be internal to an organization. They can also be separate domains of different corporate implementers. In this case it is likely that data formats, definitions, and generally policy differences will occur. Policy transfer gateways, described below, accomplish agent transfers between discrete, heterogeneous domains and different security models.

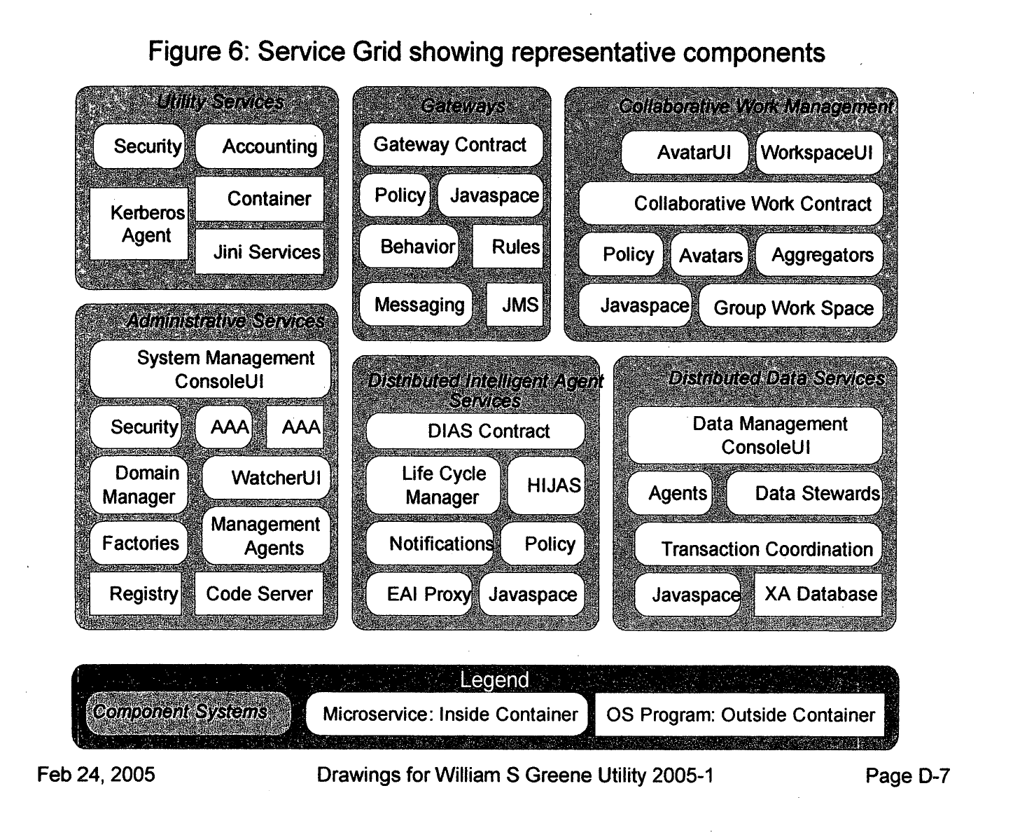

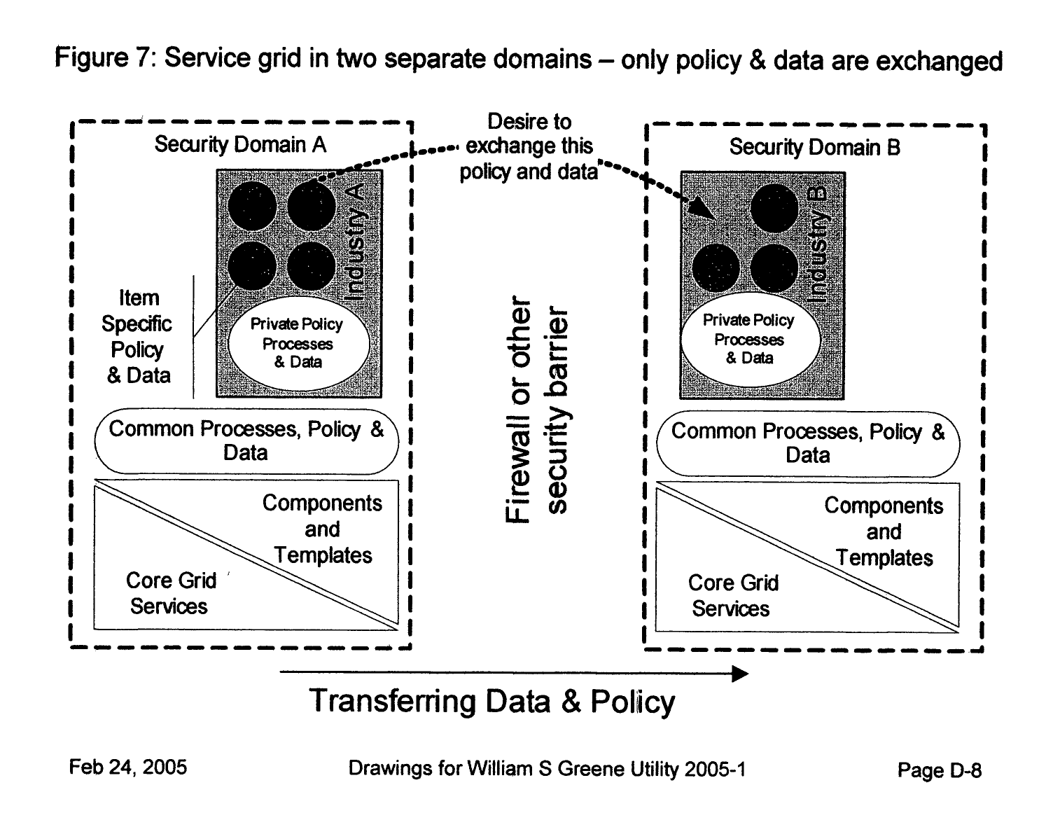

FIG. 7: “Service grid in two separate domains—only policy & data are exchanged” shows the logical application layer diagram for two separate domains (or corporate deployments). At the lowest level are the core services and templates (the components from FIG. 6 and the patterns used in assembling services into applications). Above this is a set of business polices, procedures and data which is shared among most domains and was usually distributed as part of the original service grid. Above this is a set of business polices, procedures and data which is generally agreed to and shared in common among the industries which are cooperating. This has generally been developed as a vertical industry product or through standards organizations and business associations that the separate corporations partake in. Again this block of services will be substantially identical among the sharing domains. Above this are policies, procedures and data developed by the individual domain members. This group is likely to be substantially unique per domain. Security policies, processes and data specific to the domain/corporation reside here. The information which is shared between service grid domains is isolated into specific Policy Microservices, of which there may be a large but discrete number. The novelty of this invention application is concerned with the filtering and selection of the policy and data to be exchanged, the transmission via an agent or other data representation, and the acceptance and deployment in the receiving domain of this information. It is assumed that one or many security barriers exist between the two domains.

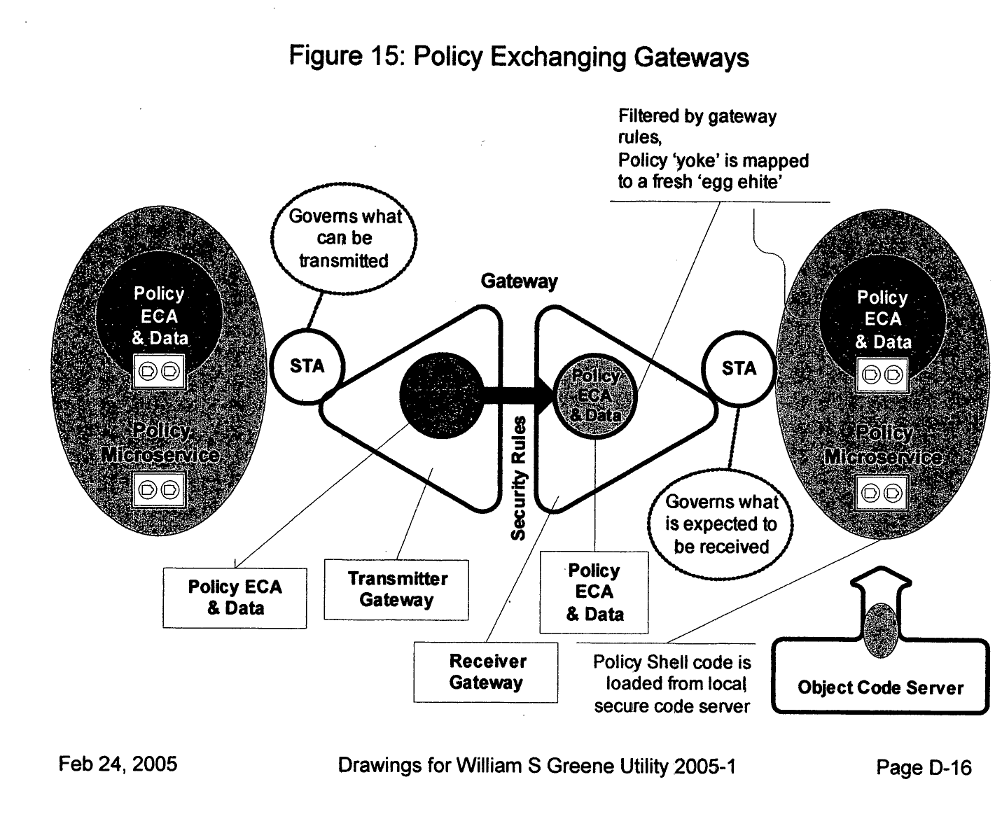

The policy and data that is exchanged is done via movement of policy agents. FIG. 15: “Policy Exchanging Gateways” is an architectural flow diagram depicting the transfer of a policy Microservice (the egg representation) from one domain to a separate domain under conditions of limited/negotiated trust. Once a policy agent has identified and attached to the Transmitter Gateway (that will direct it to the required new domain), it is examined/processed by the gateway. A service called the Service Transfer Agreement (STA) enacts the conditions and policies associated with policy agent export. STAs are described in the RossetaNet standards. In this case this is a service which implements the contracts and agreements associated with agent transfer.

STAs control outbound and inbound transcription of the policy agent kernels: Event Condition Action (ECA) statements (generally in XML/XRI encoding or as Java language) representing policy and data (XML or data structures). The outbound STA is used by the transmitting gateway to filter out any policy and data which is to remain private and not leave the domain. Either positive match logic or negative match logic can be used. (Ex: Product-identity can transfer. Customer-identity cannot transfer.) Thus a ‘policy approved’ copy of ECA and data is transmitted. An STA can also require data be added to the policy agent by incorporating data fetched from other locations via the gateway services into the kernel. Policy that is important to external treatment of the agent would generally be added this way.

The inbound STA intercepts the policy/data kernel before it is incorporated into a receiver agent. Any information which the receiver wishes to remove will be removed from the ECA and data. Local domain information can be added at this time. Once processing with the receiving STA is complete (the kernel is now conformant with local domain security and data formats), the kernel is passed to a policy-agent factory. The factory will download a clean, local copy of the policy-agent code from a locally authenticated code-server. The factory writes into this the processed kernel of ECA and data and the locally approved policy agent can begin transit of the receiver domain.

How Gateways Find Each Other and Bind:

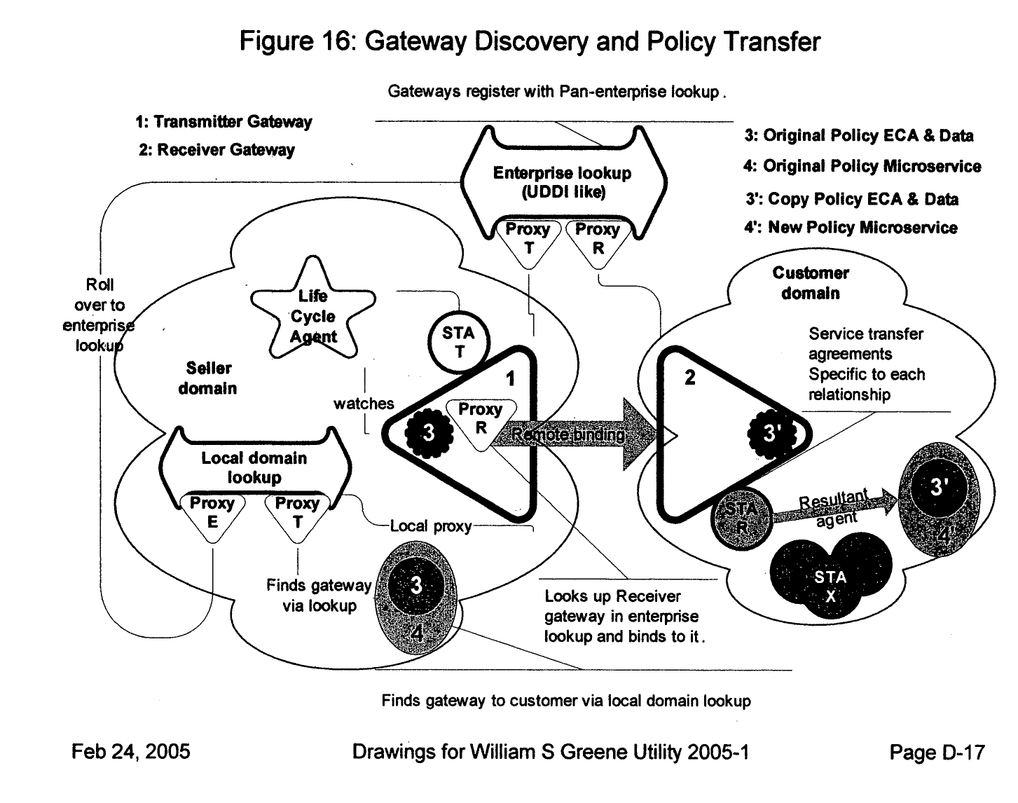

FIG. 16: “Gateway Discovery and Policy Transfer” is an architectural flow diagram depicting the process for gateways registering with an enterprise lookup service. As with other Service Grid services (see associate applications), the gateway (service community), as soon as it is deployed into containers by a life-cycle service, registers with an enterprise lookup and places a remote proxy (Jini service code) into that enterprise lookup. This proxy will identify the agent types and the domain for which the gateway can provide service. The gateway will also add a proxy to the local lookup associated with its domain. These proxies can be different, as the communication protocols used in the local domain may be different from the remote domain-to-domain protocols. (see prior art for Jini smart proxies).

When a gateway is requested to associate with a destination gateway, it finds the enterprise lookup and requests a proxy for that destination domain (which could be a different corporation). The proxy is bound by a agent-service of the gateway and used to establish service-to-service communication with the destination gateway. At this time the transmitting gateway also discovers and remote loads the STAs specifically associated with the policy agent types it will service and the destination gateways it has attached. (If the gateway-to-gateway connection is broken and does not immediate recover, these STAs will be released for other gateways to access.)

How a Policy Agent Identifies/Finds the Gateway which Will Allow Transit to the Desired Receiver Domain:

An external business process service will generally have an action or an itinerary that will invoke transfer of a policy agent from one domain to another. However, it is also possible that the receiving domain has issued a request for the policy agent instance, which the transmitting domain itinerary service is complying with. The first action is to discover and attach to the gateway which provides transit service to the destination domain.

Generally a domain will have one or more gateways that interconnect with other domains. Like any other service, a policy agent need only discover a functioning gateway, not any specific one. The policy agent, usually via an itinerary service brokering transfer of the policy agent, will discover the gateway to that target domain via the local lookup service, whereupon it downloads a proxy to that domain. Generally in the lookup process, the destination domain and the type of agent are used to select the specific domain to attach to. FIG. 16: “Gateway Discovery and Policy Transfer” is an architectural flow diagram depicting the discovery of a receiving gateway by a transmitting gateway, the binding of transfer policy, Service Transfer Agreement (STA) services, and the remote binding of the two gateways prior to policy transfer.

Normal Service Grid survivability and management services insure a supply of gateway agent communities are active as “sticky services”.

The separation of “receiving gateway” and “transmitting gateway” is a transient client-server interaction of a peer-to-peer association. A gateway can and will interact as a receiver in one transmission-instance and a transmitter in another.

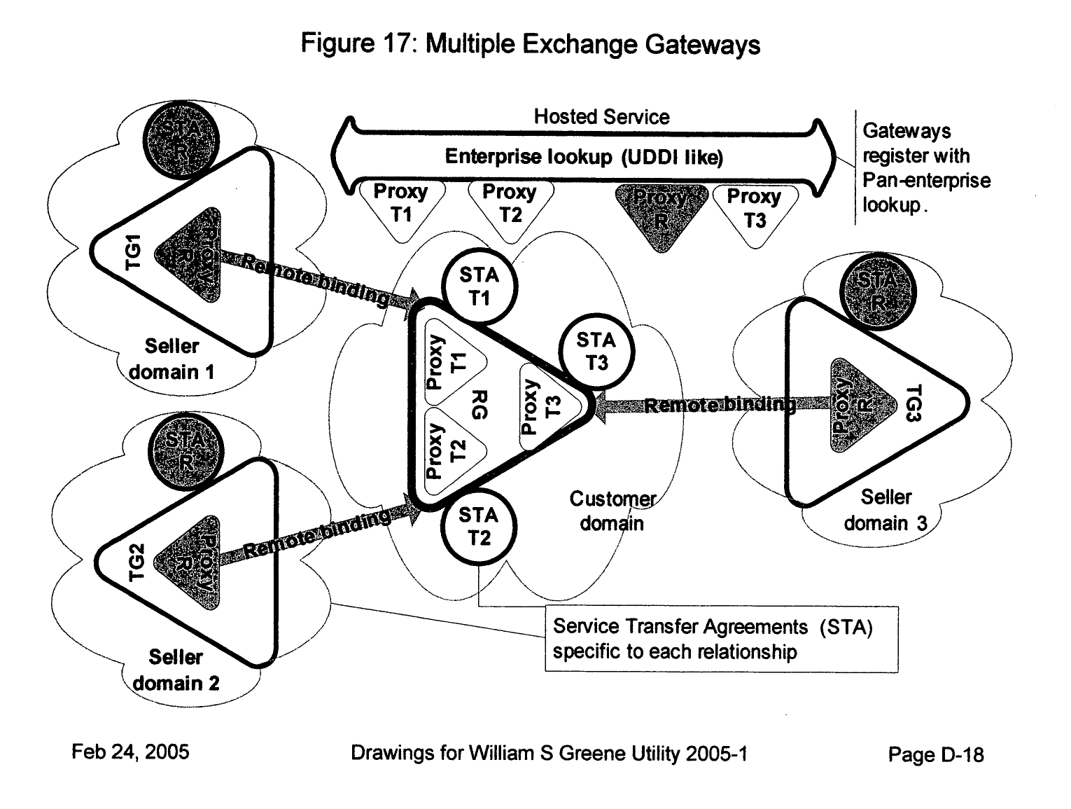

Transmitting gateways and receiving gateways may connect to more than one gateway (and are generally assumed to do so). Function of interaction of multiple gateways is symmetric; so only the receiving gateway is explained in this application. A receiving gateway is shown associating with multiple transmitting gateways in FIG. 17: “Multiple Exchange Gateways”. Each is bound via the downloading the remote proxy to the transmission gateway from an enterprise lookup and then invoking the remote binding via that proxy and also the assembling the relevant locally defined STA services.

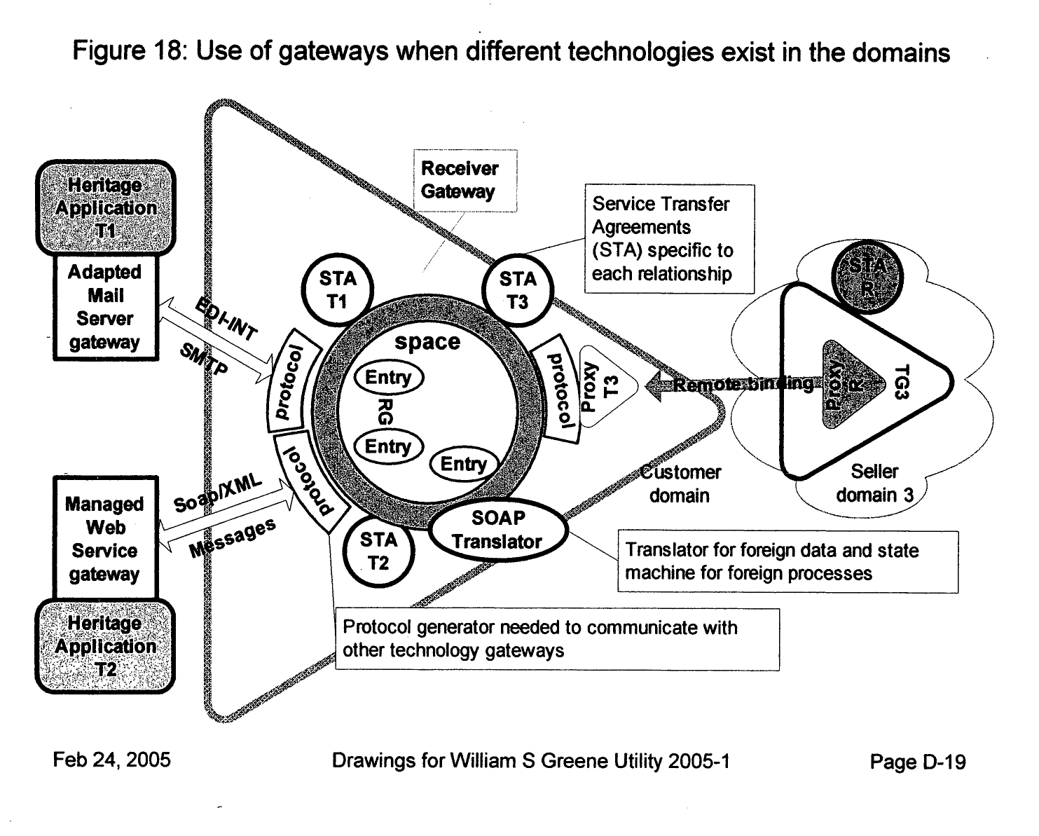

Gateways are frequently built from Javaspace cores using agent templates similar to the HIJAS subsystem in the prior referenced patent application; and as such STA services usually inherit from the Javaspace agent generic service. FIG. 18 shows a gateway blown up with a Javaspace at the core of the gateway. This architecture allows many gateways to be bound and serviced and very large numbers of policy agent transfers to occur. Simple gateways can be built as service-to-service communities bound and controlled by Aggregators.

Gateways can also be used to interconnect and transfer information components of a policy agent to non service grid communities, or to other service grid domains using protocols other than above explained transmission of the policy agent. FIG. 18: “Use of gateways when different technologies exist in the domains” is an architecture diagram showing that one receiver gateway can bind to many transmission gateways with different technologies from the Service Grid. Each foreign gateway (shown as two foreign gateways each of a different type) has a protocol connector agent loaded for that specific communication type which binds to the space inside the Service Grid Receiver Gateway. Loading of the protocol service follows the standard way space attached services are deployed. Each foreign application (T1 & T2) will have a data translator service and protocol controller (communication translators which are built from state-machine agents) service that also bind to the internal space. Messages from the Transmitter gateways pass through the protocol binding service into the Space where they become space Entries. Translators and Protocol controllers which have registered with the space for this message type fetch these from the space and process them. Messages passed into the space from the service grid ‘business process responder’ services also manifest internal to the state machine as Entries and are processed by the translator, the protocol controller and than the protocol binding agent—from which they are transmitted to the foreign gateway. Remote Service Grid Transmitter Gateways (TG3) function by passing the “yoke” of data & policy into an entry, which is then processed by a Service Trade Agreement Service and then is assembled by a factory (binding to the space) with code fetched from the receiver code server into a local Policy Agent.

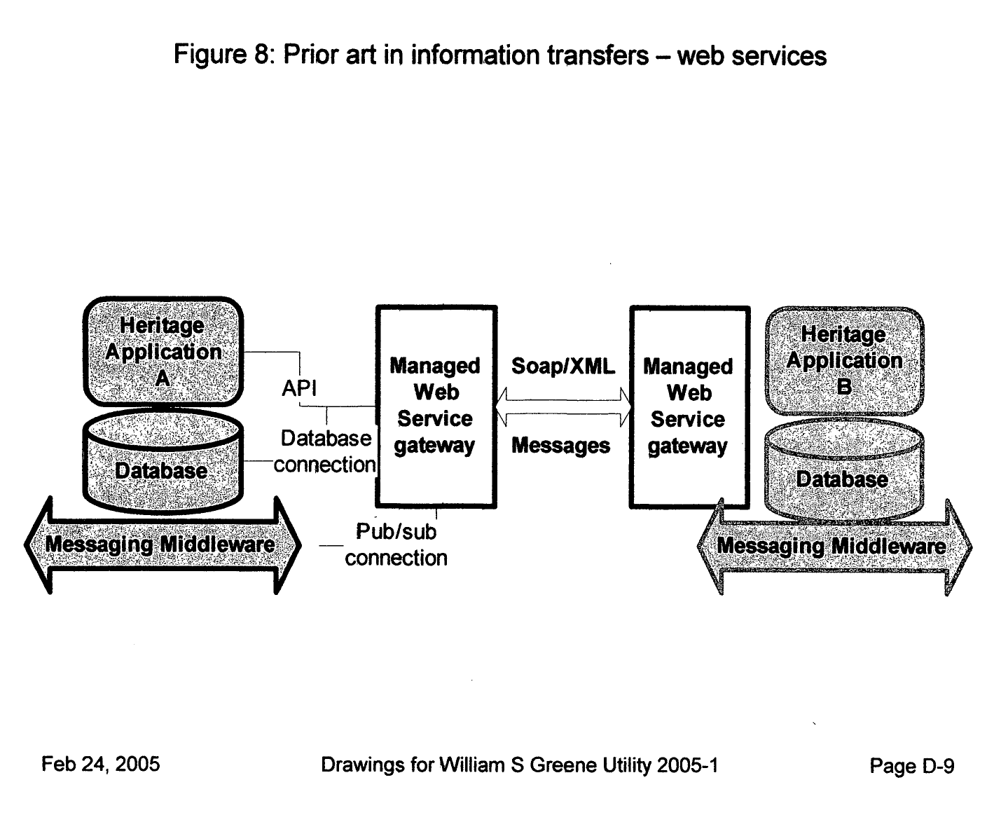

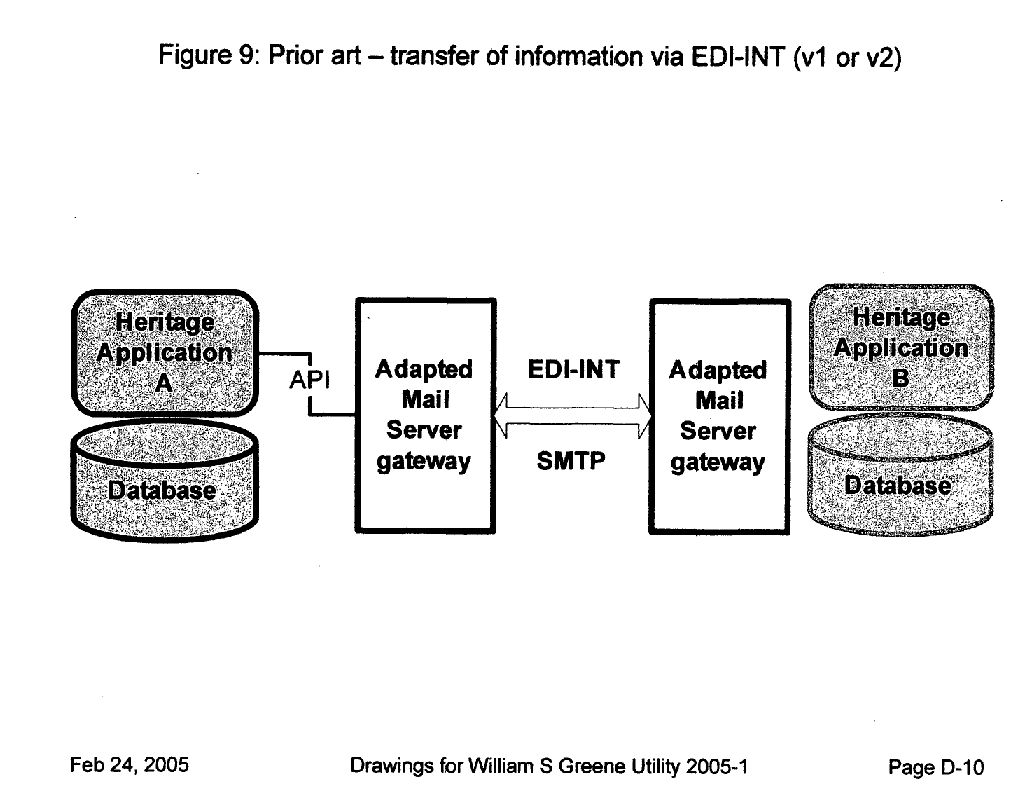

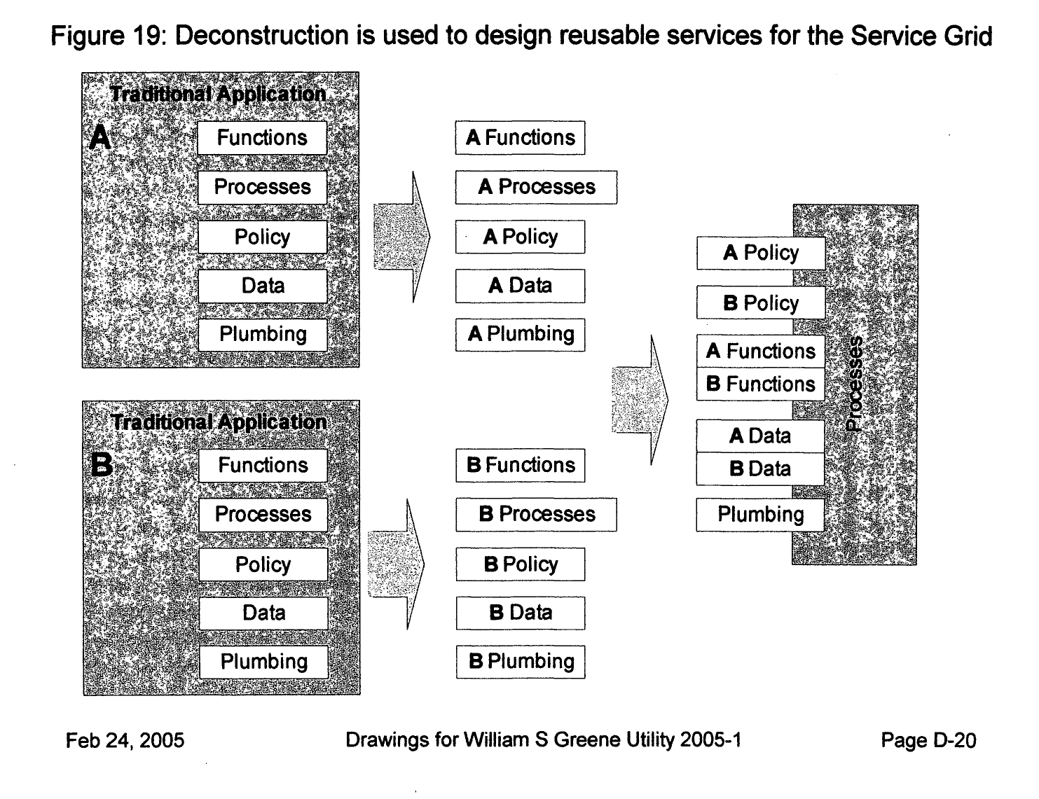

In this way, Service Grids can interact with Legacy/Heritage application communities, or with environments which do not support a security arrangement for policy-agent exchanges. However, the efficiencies and security of this approach provide much greater facilities for business interaction and automation. Therefore heritage applications can be converted systematically into Service Grid communities. FIG. 19: “Deconstruction is used to design reusable services for the Service Grid” shows the stepwise transition of how heritage applications can be broken into parts: common plumbing, common business elements and unique expressions of data and policy. This process is used when converting from existing transmission gateway applications such as shown in FIGS. 8 and 9 to the novel service architectures in this application. This model, by decomposition, comparison, and normalization, allows policies, gateways and STA services to be extracted and re-engineered from existing message exchange applications.

### Security Model for Inter-Enterprise Collaboration: Network Effect

The following section explains how a corporations participating in a supply chain would use the policy agent to track RFID tagged goods as goods move through the supply chain. It is an exemplary example of use of policy agents and gateways; but by no means is it the only use of these constructs.

A standard supply chain framework is one of inter organizational communication. The companies are working to interconnect core applications—name enterprise resource management systems (ERP) or supply chain management systems (SCM). This framework channels inventory readings into pre-existing database management systems. This is called horizontal data management. There is a lot of work going on in this area of getting core applications to communicate with each other. This is what RosettaNet and UCC is accomplishing.

Following a product through out a supply chain from point of manufacture through shipment and ultimately point of sale involves tracking over time across more than one owner. The opportunity for economic pay back increases when you can track products over time. But complexities increase both in the area of the technology that is used and in area of business perceived risks of exposing views of their business processes to outsiders who under the older prior way of doing things would never before be able to have access to that kind of information. The adoption at the second level demands an increase in ‘transparency of operations that some companies will find distressing.

In contrast to this, instead of having a horizontal process that goes into a core with the vertical integration taking place at the core, it is better to provide the vertical integration at the edge at the moment that the product's tag is first read into a system. Instead of a horizontal movement of data to the core and then vertical communication up and down the core, communication occurs from place-to-place along the edge. Transactions occur near business process where they provide maximum value and lowest latency.

As the goods move in physical space the information, data and policy about the goods moves virtually in information space as well. The interaction between the goods and the mobile agents describing the good occurs at the edges where the readers are and where the business processes need to be implemented.

Basically the ERP and SCM products are based on data movement toward big data centers with very large core applications doings lots of different things. To inter communicate between their cores they use technologies like EDI or Web services. In reality there is very little business information that is communicated.

This application replaces the big core data center, monolithic application, with a dispersed service grid with mobile agents that can push small amounts of both data and policy around all the time. Therefore, instead of having horizontal integration into the core and vertical integration at the core, this application provides integration at the edge.

Providing Local Intelligence for Tagged Items (See Reference to Prior Applications):

The Service Grid will have generic servers placed near readers. When an EID is read, it is placed in a HIJAS (Heuristic Intelligent JavaSpace Agent Subsystem) system that includes an XML JavaSpace. The class and specific identity of the object is interpreted by the system and a remote lookup of the item's master agent is made from the global distributed data service. A clone of the master agent is remotely transmitted into the generic server and placed as client to the HIJAS. The item's agent is now local. It contains the history of the tagged object, all the past locations, where it is to go, how it should respond to choices, what the system should do if the item is ‘off track’.

This Agent follows the item about as it moves through the supply chain. It keeps its remote master copy synchronized. When the item is read in a new location, the buddy is cloned to that new place and the old buddy is read into permanent storage. The item is no longer just type, vendor, and serial number.

The Agent can be encrypted and secured. It can provide features such as non-repudiation to location reads and actions taken on the items behalf. For business, this means that as the item enters or leaves a new warehouse the movement into the location cannot be altered and can server as a financial transaction. A Service Grid provides for micro accounting between the agent and the container and between the container and master accounting services. These can take the form of milestones, budget credits, or micro-currency flows.

The Agent usually will be encoded with policy. Usually these are ECA (Event, condition, Action) statements. When an even occurs, a condition is checked and if met, a specific action is initiated. Actions can be quite varied and range from simple to complex. A complex action could be a multiparty distributed transaction with alternative branches based on different transactional failures. A business example is triggering a remote check with the home office if the item is located in an area where the temperature exceeds parameters, and flagging of the Agent as item-depreciated if no continuance code is returned from the home office.

The Agent is created when the items comes into existence in the system. Everywhere it goes and everything that happens to it gets encoded in the agent and its remote master. Its history becomes permanently attached to the item and is always locally available. Complex information of almost unlimited scope can be maintained and acted on locally.

The Agent lives in a population of other agents. The tagged items can be built into dynamic associations, a virtual representation of it place in a physical system of other items. Such an association can be a pallet of crated RFID tagged boxes, or a shipping container of such. It can be a complex assembly like a machine made of separately tagged parts. It can be an assembly line. These associations are external to the agent but understand the associated agents. The associations can be made and broken in real time. Business actions can be made on the aggregate agent structures as transactional semantics.

The Agent lives within the Service Grid environment. This Mirror World of services can provide complex business support. Every Microservice in the global system can be called upon to provide extended functionality when needed. So, although an item has only identity information from the RFID tag, it gains an enormous amount of contextual and policy-driven intelligence from the software.

A service grid allows a unique benefit when it is deployed across cooperating partners in a supply chain. When partners deploy The Service Grid they are able to share sophisticated policy data regarding inventory that is simply impossible with any other system. Refined knowledge and policy gained at one location can be passed along to other supply-chain participants. This creates a powerful incentive to share a grid among trading partners.

Basically, the RFID Agent collects and stores detailed data as it moves along. Partners downstream in the supply chain can utilize the additional data provided by earlier transit points. If an Return Merchandise Authorization (RMA) is ever invoked, or the item need repair, originating supply chain members can gain access to vital history of transit and use data from the RFID agent.

The RFID Agent also stores policy. This behavioral and reaction information provides value as it moves downstream in the supply chain. Manufactures can add information about how to treat the item under environmental changes. The RFID Agent is extensible and new policy and state information can be added in downstream supply chain participants. Distribution partners can add policy, that might for example, send an automatic tracking event, triggered when the item departs a regional warehouse, so that upstream suppliers can know to replenish the item.

This potential value must be tempered with proper security considerations so that all supply chain participants can gain the benefit they desire without compromising integrity. The normal value chain using The Service Grid must be understood to be a ‘trusted’ system where everyone plays by known accepted rules. RFID-agents entering a users Service Grid community must be allowed to depart with all the information they have gained. That is, a user generally should not restrict information about where the item was warehoused and any environmental conditions that might have been recorded for that location. This is called a Service Grid Full Trust environment. Strong advantages exist when standard Service Grid service/container security is allowed to govern transit of services across organization boundaries. Far from frictionless, such a normal transit would still involve secure validation of the foreign derived service before the container will allow it to load and execute. In addition the local container will enforce an accounting transaction to be logged that provides a record that the service deployed in this specific container for this specific time.

Security is maintained through several discrete methods that include separate encryption systems and structural elements derived from the architecture of the Service Grid.

Lower level, or ‘heavy-lifting’ security is resident on servers that participate in the system. Kerberos agents are loaded into servers that will participate in the distributed system. These Kerberos agents control telnet authentication of the Service Grid Bootstrap services. Once security is passed, the bootstrap service can bring up java VMs, Jini services and containers.

Higher level, or dynamic security occurs inside the Service Grid. Here, PKI and built-in proprietary service security measures are used. The Container supports service authentication. Services are authenticated against the container in which they will run. A service launch requester must be authenticated as a client of a Life cycle or management agent service. The requestor's authorization to use the container is checked. The container authenticates the code server address passed from the managing agent.

If the service is not authenticated against a domain (life-cycle manager) and specific containers, it cannot deploy—the container will not accept it or grant it basic resources. Security alarms are propagated. If a service authenticates, but security policy does not allow deployment within a container or at a specific time, the service cannot deploy.

Following the supply chain example, within a trusted Service Grid, when a shipment of widgets enters the warehouse, a software agent, which virtualizes that widget, is launched into the local IT system. Both real security, and perceived security, becomes very important. Users of the Service Grid system must understand that their own Service Grid life-cycle managers authenticate the foreign code before it can be launched. This authentication is similar too, but more automated and more rigorous, than the authentication of remote applications loading into a PC.

By setting security policy in Event, Condition, Action (ECA) security policy agents, or by accessing policy via remote behavior service connections, a user can control the deployment of foreign agents into their system. Foreign agents can be limited to specific domains, servers and/or containers. Their access to remote services can be constrained. Any time a service would seek to relocate, security policy would again be checked.

The Agent entries inside a JavaSpace can be further secured if the user wishes. In this case, a local RFID-agent clone would proxy for the foreign RFID agents. Therefore a local service is generating all the JavaSpace entries.

But this potential value must be tempered with proper security considerations so that all supply chain participants can gain the benefit they desire without compromising integrity. A normal transit would still involve secure validation of the foreign derived service before the container will allow it to load and execute. In addition the local container will enforce an accounting transaction to be logged that provides a record that the service deployed in this specific container for this specific time.

But not all organizations will be comfortable with the direct transfer of foreign services into their service grid. Therefore a number of service exchange models are implemented:
Full Trust
Negotiated Trust
Hands-distant with Service Grid on both sides
Hands-distant with Service on only one side
Distrust of service transfer
   However, the last two converge to common implementation architecture.

Standards for Inter-organizational Supply Chain (namely the RosettaNet), have realized that for automatic exchange of order fulfillment and shipping information, and to coordinate workflows and policy between organizations, these organizations need to develop a Trading Partner Agreement (TPA). This exemplary use of the invention provides for a software-based automaticly functioning implementation of the RosettaNet recommendations for TPAs via STAs. The major Component providing this in the Service Grid is the Trading Partner Gateway (TPG), which is a specialization of the Component Gateway template. Gateways have much in common with RFID agent local domain HIJAS deployments (described in prior referenced applications), namely they are managed by a DIAS system and contain many of the specialty services found in HIJAS deployments.

Negotiated Trust Model: In the Negotiated Trust service exchange environment, the two corporations cooperate in determining what information, contained in RFID agents, can and must pass corporate barriers. These decisions about data and policy are then encoded into specific services. During normal work, these services arbitrate the exchange of services and data across the corporate boundaries. In the rare circumstances where a transfer cannot be automatically resolved, a joint Service Grid component Cooperative Work space is launched and designated users participate in manual resolution.

Trading Partner Agreements for Service Transfer Agreements (TPA-STA) are established as joint corporate-user-to-corporate-user Trading Partner Gateways (TPG). The Service Transfer Agreements (STA) services in the TGP govern exactly what information (data and policy statements) can, and what information cannot, cross these corporate boundaries. When crossing boundaries into a new corporation's implementation of Service Grid, the TPG is engaged and the STA-service is checked. This TPG service may then act as a factory for creating local RFID-agent masters and clones. The STA becomes associated (linked) to the RFID-agent and participates in multipart transactions when synchronization the original RFID agent with the local RFID agent clones.

It should be noted however; that a secure entry will be made in the RFID agent that information of such and such a nature was restricted and is therefore missing from the permanent record. This entry must give a URL reference to a governing service at the withholding user systems that future users can query for this information.

It is possible within one corporate deployment for different Domains to be established with different security policies. Such a condition may occur when one Domain is open to external user/customer interfaces, and another Domain is restricted to private corporate business. These cases can be treated as Negotiated Trust exchanges. A service transitioning between any specific Service Grid domains with security boundaries (different security considerations sometimes exist for different domains), will engage a TPG and associated STA set up to govern information exchange. An example of filtered information could be the restriction of employee salary and medical information from the general corporate directory.

There exists a possibility of policy conflicts between the local user policy service and any policy contained in the foreign policy agent. In this case each policy is weighed separately by applicable domains. Local policy will apply in all local systems and on local HIJAS subsystems. Policy in the Enterprise domain will apply to the enterprise agent and its permanent history and back-trail. Policy resolution states, —generally specifying domain of conditional events, domain in which actions take affect and relative policy priority—are recorded in the TPA-STA-services and govern these subsequent Policy evaluations and actions. Resolution of the policy takes place in the Gateway at entry of the foreign RFID agent and is then recorded in the local agent clones. This speeds local policy enactment.

The TPA-STA-service will also contain, or have links to, the trusted PKI root agents common to the two corporate security domains.

Managed Web Services—Hands-Distant with Service Grid Gateway on Both Sides:

Casual relations can exist when two corporations that have deployed service grids, yet neither have developed a strong enough partnership to engage a project to build and deploy a Trusted Partner Gateway. In these circumstances the typical information exchange model is Managed Web Services. A standard Information Gateway is implemented separately at each location. Sometimes this gateway is as simple as a specialized Microservice implementation, but usually a Gateway component is use to optimize transit protocols and multiplex transmission channels.

The organizations agree on the Web Service messages that are to be exchanged. This generally involves common understanding of the XML, common use of tools for the Web Service definition, and agreements on the work flow of messages and responses. The Gateway systems transmit these Web Service messages in a fully reliable way, guaranteeing receipt and resolving conflicts automatically or via escalation to a Cooperative Work space. This is accomplished via wrapper packages, encryption protocols, and smart reconnection proxy-to-proxy communication. Most of the time the transport protocol is SOAP, but others can be used.

Web Services Mediation with Service Grid on Only One Side:

Ordinary Web Service models are used when communicating with a trading partner that does not own an a Service Grid deployment. In this case, the laborious practices of working out a workflow and specific XML must be made. Once designed, this can be simply programmed into a Service Grid TPG that will thereafter automatically handle this communication.

However, it should be noted that reliable interaction is not possible, because the action of the foreign system are not known, do not follow the enforced standards that exist in the Service Grid, and the web service protocols are inherently unreliable.

Heritage Communication Models:

Many supply chain partners today use the EDI-INT standard for communication order and supply chain information. This standard is a extension and adaptation of the IETF Mime email format. A Service Grid provides a EDI-INT Gateway for data exchange with a trading partner's heritage application. This can also be used internally for local systems that expect EDI-INT information.

Many other communications methods are possible; some optimized for intra-corporate data transfers and others for extra-corporate data transfers.

### EXAMPLE SCENARIO ON MOVEMENT OF AGENT IN SUPPLY CHAIN

How Data and Policy Transfer Occurs in the Service Grid Supply Chain Example:

First, the data and policy transferred is inside the RFID agent and is strictly associated with the actions that might be taken on the item it is tracking. Other information, which might be important, but not related to the item in the supply chain, is never incorporated in the RFID agent; such information might be the total count of items manufactured that quarter—important to business issues and profitability, but not the specific item. So access is never given directly to a company's core systems and business practices, only to the agent.

The Following Example Tracks Goods from Materials Supplier Via a Shipper to a Warehouse:

In a partially trusted environment, the materials suppliers would create an RFID agent to track their shipment allotment and encode it with the RFID identity tag number. Then as it is shipped, the RFID agent learns the destination and then ‘finds’ the gateway that controls transfer from the material company to the shipping company and also to the manufacture's gateway. These gateways, which are on the materials side and owned and controlled by them, request an agent copy. The gateway on the receiver's side pulls a blank agent type from its own secure code base. The materials gateway then copies itinerary and value information (for insurance) into the shippers RFID tracking agent; elsewhere another pair-wise gateway copies the pricing info, makeup, product history into the manufacturer's blank.

Both these agents travel in their respective service grid networks to the destination point. Along the way, the Shipping RFID agent interacts with shipping processes to explain where it is bound and when it must get there and what special conditions the item needs. It finds and collects data from sensors along the way and records where the product was at what time.

The manufacturers agent travels directly to the expected shipping destination (which could be a set of locations). When the agent leaves the transit network, a transit to receiver gateway copies over the shipper data. A Service Grid then discovers and combines the information from both agents into one. When the item tag is read, this agent then provides policy instructions on how the item should be treated. This is combined with policy that is resident in the local system that is applicable to all goods of this type. For example a dangerous item agent would request storage in HAZMAT facility. The local receiving station requires HAZMAT items must go to area XX in dedicated carts. The item is also flagged for special treatment by the receiving agent.

Example of how information flows back and forth in the chain: The hazmat item could have a trigger that says it communicates an “I am well” release back to the shipper. This sets up an Service grid core side service-to-service transaction message with this status, aimed at the identity of the shippers RFID agent. That agent notifies its local system of receipt of the message and the ‘responsibility’ of the shipper is cleared. This message could use the ‘multiple path’ approach enabled by a third party trust product.

Now at the time of transfer of information at a gateway, the code comes from the destination side, the data and policy statements and states come from the originator side. The originator decides what it will offer; the destination decides what it will receive. Each can flag missing info that was expected and offered info that was rejected.

If some data inside an agent is encrypted and controlled for release by internal policy, this encrypted transfer must be ‘trusted’ by the receiver. When in the receiver network, there is a system that has an authorization key. When it requests with the key, it gets the information. The supplier trusts the receiver to keep the information safe once it is copied out. If this trust does not exist, than the system is built with process queries instead of data transfers.

1. Claim system, method, and software implemented system of services for Gateways in a distributed computer grid for provision of information and agent transfer between domains in distributed computing
providing enhanced security and management to multiple domain grids and allowing intercommunications between the different grid domains
providing for data exchange, policy exchange, and agent exchange between grids or grid domains
providing the registration of gateways with enterprise lookups, the discover and binding of remote gateways, the discovery of gateway pairs by local domain services, the secure, filtered transfer if policy (Event, Condition Action statements) and data from one domain to another, the securing of agent code through use of a local, authenticated code server, and the assembling of completed transfers of agents from policy/data kernels and the local agent code
providing simple gateway to gateway transfers, as well as associations of multiple gateways, and interconnection with non service grid domains via heritage protocols.

2. Claim system, method, and software implemented system of services for providing enhanced security and management to supply chains:
providing data exchange, policy exchange, and agent exchange between supply chain nodes and supply chain partners using policy agents—specifically when technical environments are heterogeneous, different policy and security domains are present, and trust models are not identical by filtering and adding information via STAs of the respective transmitting and receiving domains,
facilitating enhanced methods of supply chain automation when using barcodes and RFID tags to identify and track goods through supply chains and consumer uses.

3. Claim the system, method, and software implemented system of services for a Security Domain, as a multidimensional demarcation boundary in a community of Microservices and heritage applications
providing the multi-tiered security design, technology and processes associated with secure and reliable service grids
providing trust models associated with use of gateways to arbitrate exchange of policy and data,
providing automatic enforcement of TPAs via STA services.
